(19) United States
(12) Patent Application Publication
(10) Pub. No.: US 2026/0339158 A1
(43) Pub. Date: Oct. 29, 2026

(54) ELECTRO-OPTIC DISPLAYS AND METHODS FOR PREPARING THE SAME

(71) Applicant: E Ink Corporation, Billerica, MA (US)

(72) Inventor: Yunyi GAO, Chelmsford, MA (US)

(21) Appl. No.: 19/661,076

(22) Filed: Apr. 28, 2026

Related U.S. Application Data
(60) Provisional application No. 63/796,029, filed on Apr. 28, 2025.

(51) Int. Cl. G02F 1/167; C08G 77/46; C08K 9/10; G02F 1/1675; G02F 1/1676

(52) U.S. Cl. CPC G02F 1/167; C08G 77/46; C08K 9/10; G02F 1/1676; G02F 2001/1678

(57) ABSTRACT

Electro-optic media and electro-optic displays comprising the same are disclosed. Methods for preparing the electro-optic displays are also disclosed. Desirable electric optical performances, such as improved contrast ratio (CR), can be achieved by the electro-optic displays disclosed herein.

### CROSS REFERENCE TO RELATED APPLICATIONS

This application claims priority to U.S. Provisional Patent Application Ser. No. 63/796,029, filed Apr. 28, 2025, the content of which is incorporated by reference in its entirety.

### BACKGROUND OF THE INVENTION

This invention relates to novel formulations for use in the fabrication of electro-optic displays, which provide improved electric optical performances.

One type of electro-optic display is the particle-based electrophoretic display, in which a plurality of charged particles move through a fluid under the influence of an electric field. Electrophoretic displays can have attributes of good brightness and contrast, wide viewing angles, state bistability, and low power consumption when compared with liquid crystal displays. Typically, the charged particles are encapsulated to defeat long-term settlings. The charged particles can be encapsulated in microcapsules or small containers, such as an embossed film of hexagonal close-packed wells that are filled with charged particles and sealed with a sealing layer.

A typical microcapsule electrophoretic display has a substantially two dimensional arrangement of microcapsules each having therein an electrophoretic composition of a dielectric fluid and a suspension of charged pigment particles. The microcapsules can be formed by interfacial polymerization, in-situ polymerization or other known methods such as physical processes, in-liquid curing or simple/complex coacervation. The microcapsules, after their formation, may be “printed” into or coated on a transparent conductor film. The microcapsules may also be immobilized within a transparent matrix or binder that is itself sandwiched between the two electrodes.

The walls surrounding the discrete microcapsules in an encapsulated electrophoretic medium could be replaced by a continuous phase, thus producing a so-called polymer-dispersed electrophoretic display, in which the electrophoretic medium comprises a plurality of discrete droplets of an electrophoretic fluid and a continuous phase of a polymeric material, and that the discrete droplets of electrophoretic fluid within such a polymer-dispersed electrophoretic display may be regarded as capsules or microcapsules even though no discrete capsule membrane is associated with each individual droplet; see for example, the aforementioned U.S. Pat. No. 6,866,760. Accordingly, for purposes of the present application, such polymer-dispersed electrophoretic media are regarded as sub-species of encapsulated electrophoretic media.

An encapsulated electrophoretic display provides further advantages, such as the ability to print, coat, or spray the display materials on a wide variety of flexible and rigid substrates, including work pieces with non-planar morphology, such as an automobile body panel. (Use of the word “printing” is intended to include all forms of printing and coating, including, but without limitation: pre-metered coatings such as patch die coating, slot or extrusion coating, slide or cascade coating, curtain coating; roll coating such as knife over roll coating, forward and reverse roll coating; gravure coating; dip coating; spray coating; meniscus coating; spin coating; brush coating; air knife coating; silk screen printing processes; electrostatic printing processes; thermal printing processes; ink jet printing processes; and other similar techniques.) Thus, the resulting display can be flexible. Further, because the display medium can be printed (using a variety of methods), the display itself can be made inexpensively.

Problems known to occur in electro-optic displays include degradation of the performance, such as decreased contrast ratio (CR) of the display with decreasing temperatures (e.g., at −20 °C). However, many applications of the electro-optic displays, such as outside signage, require a range of operational temperatures (e.g., from −20 °C to 65 °C). Reduced contrast ratio in cold weather can significantly affect performance and possibly result in electro-optic displays that are unsuitable for such service. Thus, there remains a need for electro-optic displays with improved contrast ratio at low temperatures.

### BRIEF SUMMARY OF THE INVENTION

Disclosed herein are electro-optic media, electro-optic displays comprising the same, and methods for preparing the electro-optic displays.

One aspect of the present disclosure provides an electro-optic medium comprising a continuous phase and a discontinuous phase. The discontinuous phase comprises a plurality of capsules and the continuous phase surrounds the discontinuous phase and comprises a binder, a rheology modifier, and a surfactant. The surfactant comprises a silicone polyether surfactant.

In some embodiments, the silicone polyether surfactant comprises a PEG/PPG-dimethicone. In some embodiments, each capsule comprises a first, a second, a third, and a fourth different kind of pigment particles. In some embodiments, the four different kinds of pigment particles are white, yellow, magenta, and cyan pigment particles.

Another aspect of the present disclosure provides an electro-optic display comprising a light-transmissive top electrode; an electro-optic medium comprising a continuous phase and a discontinuous phase; and a backplane electrode. The discontinuous phase comprises a plurality of capsules and the continuous phase surrounds the discontinuous phase and comprises a binder, a rheology modifier, and a surfactant. The surfactant comprises a silicone polyether surfactant.

In some embodiments, the silicone polyether surfactant comprises a PEG/PPG-dimethicone. In some embodiments, each capsule comprises a first, a second, a third, and a fourth different kind of pigment particles. In some embodiments, the four different kinds of pigment particles are white, yellow, magenta, and cyan pigment particles.

Another aspect of the present disclosure provides a method for preparing an electro-optic display. The method comprises providing a first subassembly comprising an electro-optic medium layer and a first substrate, the electro-optic medium comprising a continuous phase and a discontinuous phase; providing a second subassembly comprising a backplane electrode; and laminating the two subassemblies to one another using a first lamination adhesive so that the electro-optic medium layer is disposed between the first substrate and the backplane electrode. The discontinuous phase comprises a plurality of capsules and the continuous phase surrounds the discontinuous phase and comprises a binder, a rheology modifier, and a surfactant. The surfactant comprises a silicone polyether surfactant.

In some embodiments, the first substrate comprises a light-transmissive top electrode. In some embodiments, the first substrate comprises a release sheet and the method comprises laminating the first subassembly to a light-transmissive top electrode using a second lamination adhesive.

In some embodiments, the silicone polyether surfactant comprises a PEG/PPG-dimethicone. In some embodiments, each capsule comprises a first, a second, a third, and a fourth different kind of pigment particles. In some embodiments, the four different kinds of pigment particles are white, yellow, magenta, and cyan pigment particles.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention.

FIG. 1 shows a representative cross-section of a four-particle electro-optic display wherein the electro-optic medium is encapsulated in microcapsules.

FIG. 2 shows an exemplary schematic cross-section through a front plane laminate showing the manner in which the release sheet is peeled from the laminate prior to incorporation of the laminate into a display.

FIG. 3 shows a simple push pull waveforms that can be used to achieve a set of primary colors in an optimized system including one reflective (white) particle, and three subtractive (cyan, yellow, magenta) particles, wherein two particles are negatively charged, but have different magnitudes, and two particles are positively charged, but have different magnitudes.

FIG. 4 shows the preferred position of each of the four sets of particles to produce eight standard colors in a white-cyan-magenta-yellow (WCMY) four-particle electrophoretic display, wherein the white particles are reflective and the cyan, magenta, and yellow particles are absorptive.

FIG. 5A illustrates an exemplary equivalent circuit of a single pixel of an electro-optic display that uses an active matrix backplane with a storage capacitor.

FIG. 5B illustrates an exemplary equivalent circuit of a simplified electro-optic display of the invention, allowing driving in a row-column format.

FIG. 6 illustrates an exemplary electro-optic display that includes a display module. The electro-optic display also includes a processor, memory, one or more power supplies, and a controller. The electro-optic display may also include sensors to allow the electro-optic display to adjust operational parameters based upon the ambient environment, e.g., temperature and illumination.

FIG. 7 compares the CR at −20 °C of 1471-82A-1 (control) and 1471-82B-1 (slurry with Silsurf® CR 1115).

FIG. 8 compares the dark state (DS) L* (using c*<20) and white state (WS) L* (using c*<5) of 1471-82-A-1 (control) and 1471-82-B-1 (with Silsurf® CR 1115).

FIG. 9 compares the L*c* plots of 1471-82-A-1 (control) and 1471-82-B-1 (with Silsurf® CR 1115).

FIG. 10 shows the impedance of MCC PIXs. The orange line represents the control MCC2.3 PIX, the blue line represents MCC 2.3 PIXs with Silsurf® CR 1115.

### DETAILED DESCRIPTION OF THE INVENTION

Disclosed herein are electro-optic media and electro-optic displays comprising the same. Methods for preparing the electro-optic displays are also disclosed. In the past, the particle-based electro-optic displays comprising colored pigments (e.g., the Micro Capsule Color (MCC) system) have suffered from degradation of performances at low temperatures (e.g., −20 °C), such as decreased contrast ratio (CR). The electro-optic displays comprising the formulations described herein display improved electro-optic performances, such as improved contrast ratio, consistently higher white state (WS) L*, and/or consistently lower dark state (DS) L* at reduced temperatures.

### Electro-Optic Display

The term “electro-optic”, as applied to a material or a display, is used herein in its conventional meaning in the imaging art to refer to a material having first and second display states differing in at least one optical property, the material being changed from its first to its second display state by application of an electric field to the material. Although the optical property is typically color perceptible to the human eye, it may be another optical property, such as optical transmission, reflectance, luminescence or, in the case of displays intended for machine reading, pseudo-color in the sense of a change in reflectance of electromagnetic wavelengths outside the visible range.

Some electro-optic materials are solid in the sense that the materials have solid external surfaces, although the materials may, and often do, have internal liquid- or gas-filled spaces. Such displays using solid electro-optic materials may hereinafter for convenience be referred to as “solid electro-optic displays”. Thus, the term “solid electro-optic displays” includes rotating bichromal member displays, encapsulated electrophoretic displays, microcell electrophoretic displays and encapsulated liquid crystal displays.

An electro-optic display, e.g., an electrophoretic display, may comprise a layer of an electro-optic medium and at least two other layers disposed on opposed sides of the electro-optic medium, one of these two layers being an electrode layer. In most such displays both the layers are electrode layers, and one or both of the electrode layers are patterned to define the pixels of the display. For example, one electrode layer may be patterned into elongate row electrodes and the other into elongate column electrodes running at right angles to the row electrodes, the pixels being defined by the intersections of the row and column electrodes. Alternatively, and more commonly, one electrode layer has the form of a single continuous (light-transmissive) electrode and the other electrode layer is patterned into a matrix of pixel electrodes, each of which defines one pixel of the display.

The term “light transmissive” is used in this patent and herein to mean that the layer thus designated transmits sufficient light to enable an observer, looking through that layer, to observe the change in display states of the electro-optic medium, which will normally be viewed through the light transmissive electrode layer and adjacent substrate (if present); in cases where the electro-optic medium displays a change in reflectivity at non-visible wavelengths, the term “light-transmissive” should be interpreted to refer to transmission of the relevant non-visible wavelengths.

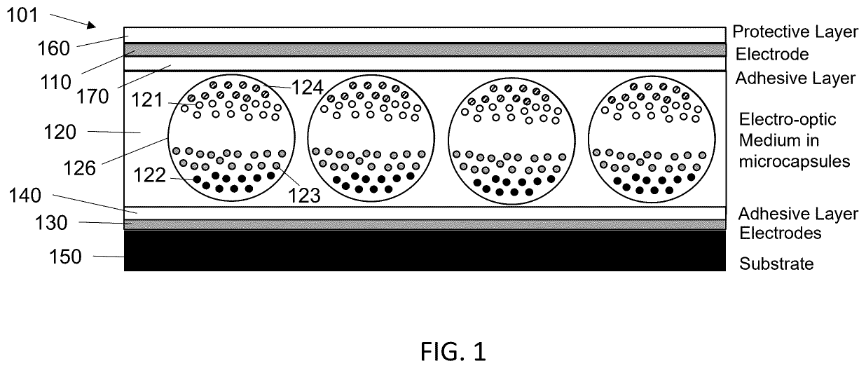

FIG. 1 illustrates an example of an electro-optic display comprising microcapsules. An electro-optic display (101) typically includes a top transparent electrode 110, an electro-optic medium 120, and a bottom electrode 130, which is often a pixel electrode of an active matrix of pixels controlled with thin film transistors (TFT). However, the bottom electrode 130 can be a singular larger electrode, such as a graphite backplane, a film of PET/ITO, a metalized film, or a conductive paint. The entire display stack may be disposed on a substrate 150, which may be rigid or flexible. The display may also include a protective layer 160, which may simply protect the top electrode 110 from damage, or it may envelop the entire display to prevent ingress of water, etc. While the electro-optic medium is depicted in FIG. 1 as being encapsulated in microcapsules, the electro-optic medium can also be encapsulated in microcells, e.g., embossed microcells that are filled with the electro-optic medium and then sealed with a sealing layer.

The manufacture of a three-layer electro-optic display normally involves at least one lamination operation. For example, manufacturing of an electrophoretic display may comprise coating an electrophoretic medium comprising capsules in a binder on to a flexible substrate comprising indium-tin-oxide (ITO) or a similar conductive coating (which acts as one electrode of the final display) on a plastic film, and drying the capsules/binder coating to form a coherent layer of the electrophoretic medium firmly adhered to the substrate. Separately, a backplane, containing an array of pixel electrodes and an appropriate arrangement of conductors to connect the pixel electrodes to drive circuitry, is prepared. To form the final display, the substrate having the capsule/binder layer thereon is laminated to the backplane using a lamination adhesive. In some embodiments, the backplane is flexible and is prepared by printing the pixel electrodes and conductors on a plastic film or other flexible substrate. The obvious lamination technique for mass production of displays by this process is roll lamination using a lamination adhesive. Similar manufacturing techniques can be used with other types of electro-optic displays. For example, a microcell electrophoretic medium or a rotating bichromal member medium may be laminated to a backplane in substantially the same manner as an encapsulated electrophoretic medium.

U.S. Pat. No. 6,982,178 describes a method of assembling a solid electro-optic display (including an encapsulated electrophoretic display) which is well adapted for mass production. This patent describes a so-called “front plane laminate” (“FPL”) which comprises, in order, a light-transmissive electrically-conductive layer; a layer of a solid electro-optic medium in electrical contact with the electrically-conductive layer; an adhesive layer; and a release sheet. Typically, the light-transmissive electrically-conductive layer will be carried on a light-transmissive substrate, which is preferably flexible, in the sense that the substrate can be manually wrapped around a drum (say) 10 inches (254 mm) in diameter without permanent deformation. The substrate will typically be a polymeric film, and will normally have a thickness in the range of about 1 to about 25 mil (25 to 634 μm), preferably about 2 to about 10 mil (51 to 254 μm). The electrically-conductive layer is conveniently a thin metal or metal oxide layer of, for example, aluminum or ITO, or may be a conductive polymer. Poly(ethylene terephthalate) (PET) films coated with aluminum or ITO are available commercially. Such films are available in bulk from various producers, such as Saint Gobain.

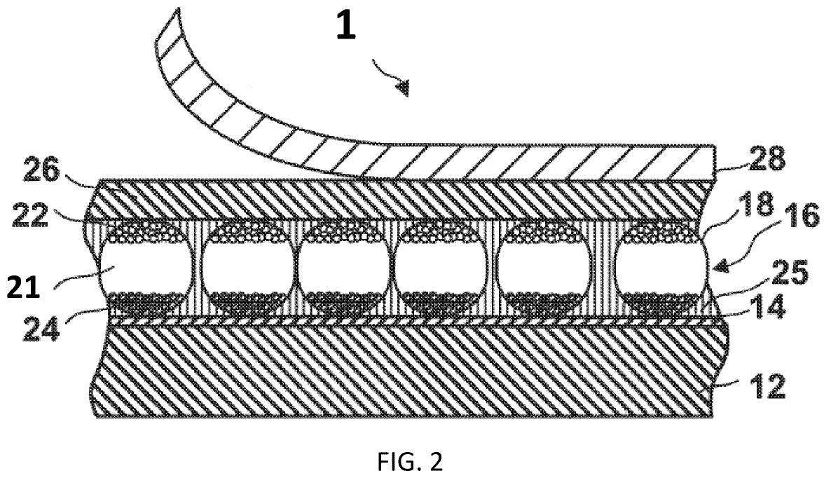

FIG. 2 shows an exemplary cross-section view of a front plane laminate with the release sheet being peeled from the laminate prior to incorporation of the laminate into a display. As shown in FIG. 2, the laminate (generally designated 1) comprises a light transmissive substrate 12, which has the form of a transparent plastic film. Although not shown in FIG. 2, the substrate 12, the lower surface of which (as illustrated in FIG. 2) forms the viewing surface of the final display, may have one or more additional layers, for example a protective layer to absorb ultra-violet radiation, barrier layers to prevent ingress of oxygen or moisture into the final display, and anti-reflection coatings to improve the optical properties of the final display. The substrate 12 carries a thin light-transmissive electrically-conductive layer 14, preferably of ITO, which acts as the front electrode in the final display.

A layer (generally designated 16) of an electro-optic medium is deposited upon, and in electrical contact with, the conductive layer 14. The electro-optic medium comprises a plurality of microcapsules, each of which comprises a capsule wall 18 containing a hydrocarbon-based liquid 21 in which are suspended two kinds of charged pigment particles. In some embodiments, a layer of adhesive (not drawn) may be present between the electro-optic medium layer and the PET/ITO layer. Whiles the capsules depicted in FIG. 2 only contain two kinds of pigment particles, the electro-optic media may also comprise three, four, or more than four sets of different kinds of charged pigment particles. The microcapsules are retained within a binder 25. The laminate 1 further comprises a layer 26 of lamination adhesive coated over the electro-optic medium layer 16 and a release layer 28 covering the adhesive layer 26. The release layer may be provided with any appropriate release coating, for example a silicone coating. As illustrated at the left side of FIG. 2, the release layer 28 is peeled from the adhesive layer 26 before the laminate is laminated, by means of the adhesive layer 26, to a backplane to form the final display.

As an alternative to a “simple” FPL, as described above, U.S. Pat. No. 7,561,324 describes a so-called “double release sheet” which is a simplified version of the front plane laminate of U.S. Pat. No. 6,982,178. One form of the double release sheet comprises a layer of a solid electro-optic medium sandwiched between two adhesive layers, one or both of the adhesive layers being covered by a release sheet. Another form of the double release sheet comprises a layer of a solid electro-optic medium sandwiched between two release sheets. Both forms of the double release film are intended for use in a process generally similar to the process for assembling an electro-optic display from a front plane laminate (FPL) already described, but involving two separate laminations; typically, in a first lamination the double release sheet is laminated to a front electrode to form a front sub-assembly, and then in a second lamination the front sub-assembly is laminated to a backplane to form the final display, although the order of these two laminations could be reversed if desired.

U.S. Pat. No. 7,839,564 describes a so-called “inverted front plane laminate”, which is a variant of the front plane laminate described in the aforementioned U.S. Pat. No. 6,982,178. This inverted front plane laminate comprises, in order, at least one of a light-transmissive protective layer and a light-transmissive electrically-conductive layer; an adhesive layer; a layer of a solid electro-optic medium; and a release sheet. This inverted front plane laminate is used to form an electro-optic display having a layer of lamination adhesive between the electro-optic layer and the front electrode or front substrate; a second, typically thin layer of adhesive may or may not be present between the electro-optic layer and a backplane. Such electro-optic displays can combine good resolution with good low temperature performance.

The front plane laminate of the present disclosure is well adapted for mass production. For example, a roll of a commercial metallized plastic film may be converted to the front plane laminate by a roll-to-roll coating process using conventional commercial coating equipment. The metallized plastic film is first coated with a slurry of capsules in binder, as described in application Ser. No. 10/063,803 (now U.S. Pat. No. 6,822,782), and this capsule layer is dried. A layer of adhesive, for example the aforementioned aqueous urethane resin NeoRez R-9320, is then coated over the capsule layer and dried. The release sheet is then applied over the adhesive, and the combined front plane laminate can then be formed into rolls ready for storage and/or transportation. When it is desired to use the front plane laminate in the construction of displays, the laminate can be unrolled and cut into pieces of the size required for individual displays or groups of displays (in some cases, it may be convenient to laminate multiple displays in a single operation and then separate individual displays at a later stage) using conventional commercial apparatus.

The release sheet used in the front plane laminate of the present disclosure can be of any known type, provided of course that it does not contain materials which might adversely affect the properties of the electro-optic medium, and numerous suitable types of release sheet will be known to those skilled in the art. Typical release sheets comprise a substrate such as paper or a plastic film coated with a low surface energy material, for example a silicone.

Adhesive compositions for laminate structures are generally known. They are used to adhere together different layers of the laminate structure. Such adhesive compositions may comprise, for example, hot-melt type adhesives and/or wet-coat adhesives, such as polyurethane-based adhesives. In some embodiments, the adhesive composition may comprise a UV-cured adhesive.

One aspect of the present disclosure provides an electro-optic display. The display comprises a light-transmissive top electrode; an electro-optic medium comprising a continuous phase and a discontinuous phase; and a backplane electrode. The discontinuous phase comprises a plurality of capsules. The continuous phase surrounds the discontinuous phase and comprises a binder, a rheology modifier, and a surfactant. The surfactant comprises a silicone polyether surfactant.

The electro-optic media disclosed in the multiple embodiments of the present disclosure may also be incorporated in the electro-optic displays and assemblies disclosed herein or prepared according to the methods disclosed herein.

The performance of electro-optic displays disclosed herein or prepared according to the methods disclosed herein may be evaluated using a variety of parameters. In some embodiments, the performance of the display may be evaluated by the level of image sticking or “ghosting” observed from the display. In some embodiments, the performance of the display may be evaluated by the contrast ratio (CR) of the display. In some embodiments, the performance of the display may be evaluated by the color gamut of the display. In some embodiments, the performance of the displays may be evaluated by the white state (WS) of the display. In some embodiments, the performance of the displays may be evaluated by the dark state (DS) L* of the display. In some embodiments, the performance of the display may be evaluated by the resolution of the display. In some embodiments, the performance of the display may be evaluated by image stability of the display. In some embodiments, the performance of the display may be evaluated by the amount of cloudy spot mura and/or panther mura observed. “Mura” is a generalized term for defects in the sealing layer that results in sub-optimal optical states when viewed through a microscope. Cloudy spot mura looks like evaporated water spots under the microscope while panther mura appears as streaks. In some embodiments, the performance of the display may be evaluated by the amount of time it takes for the display to produce one or more independent colors. In some instances, two or more of the foregoing parameters may be evaluated.

For the electro-optic displays described herein, color contamination should be minimized to the point that the colors formed are commensurate with an industry standard for color rendition. One of the standards is SNAP (the standard for newspaper advertising production), which specifies L*, a* and b* values for each of the eight primary colors (red, green, blue, cyan magenta, yellow, black and white) by using The CIELAB color system. Alternatively, a color space may be described using the CIE L*C*h system.

The term “contrast ratio” is defined as the ratio of the % reflectance of an electro-optic display at the Dmin state to the % reflectance of the display at the Dmax state. The term “Dmin” refers to the minimum optical density achievable by a display. The term “Dmax” refers to the maximum optical density achievable by a display.

Measurement of the contrast ratio may involve driving the electro-optic display to one or more optical rail states. The term “optical rail state” refers to an extreme optical state of the display. The optical rail states may or may not be black and white. For example, the optical rail states may be blue and yellow states.

The term “gray state” is used herein in its conventional meaning in the imaging art to refer to a state intermediate two extreme optical states of a pixel, and does not necessarily imply a black-white transition between these two extreme states.

In some embodiments, the contrast ratio of the electro-optic display disclosed herein may be evaluated using Push-Pull Test (PPS). For example, the display may be driven to a rail state, then undergoes one or more PPS cycles at a designated temperature. Contrast ratio, WS L*, and DS L* of the display may be measured after one or more cycles of PPS are performed.

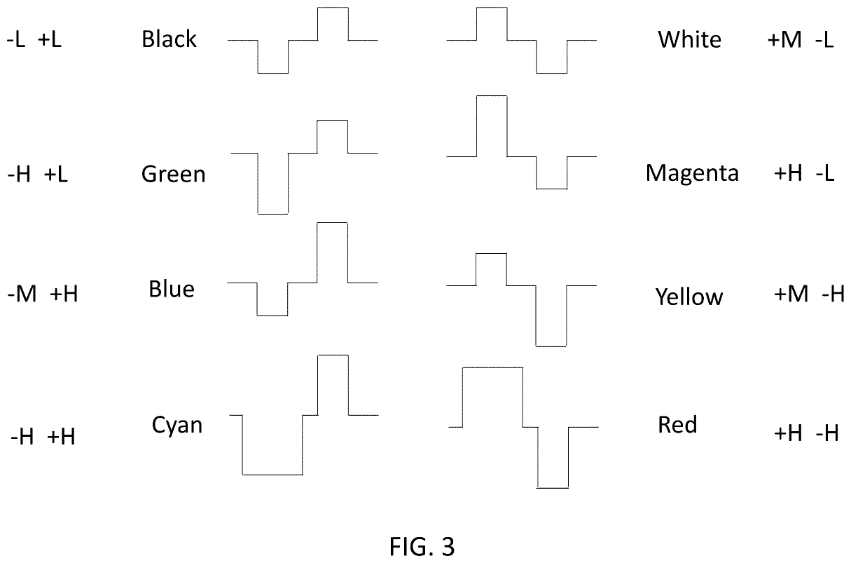

FIG. 3 shows exemplary waveforms (in simplified form) used to drive a four-particle color electro-optic display system. Such waveforms have a simple “push-pull” structure: i.e., they consist of a dipole comprising two pulses of opposite polarity. The magnitudes and lengths of these pulses determine the color obtained. At a minimum, there should be five such voltage levels. FIG. 3 shows high and low positive and negative voltages, as well as zero volts. Typically, “low” (L) refers to a range of about 5-15V, while “high” (H) refers to a range of about 15-30V. In general, the higher the magnitude of the “high” voltages, the better the color gamut achieved by the display. The “medium” (M) level is typically around 15V; however, the value for M will depend somewhat on the composition of the particles, as well as the environment of the electro-optic medium. If only three voltages are available (i.e., +V_{high}, 0, and −V_{high}) it may be possible to achieve the same result as addressing at a lower voltage (say, V_{high}/n where n is a positive integer >1) by addressing with pulses of voltage V_{high} but with a duty cycle of 1/n. A particle set useful with the push-pull waveforms of FIG. 3 may include negatively-charged white particles, negatively-charged yellow particles, positively-charged magenta particles, and positively-charged cyan particles.

While FIG. 3 shows an exemplary set of PPS waveforms, different (e.g., longer and more complex) waveforms may be adopted when evaluating the display.

In some embodiments, the electro-optic display disclosed herein or prepared according to the methods disclosed herein has a contrast ratio of at least 5, at least 6, at least 7, at least 8, at least 9, at least 10, at least 11, at least 12, at least 13, at least 14, at least 15, at least 16, at least 17, at least 18, at least 19, at least 20, at least 21, at least 22, at least 23, at least 24, or at least 25, at −20 °C after 2, 4, 6, 8, 10, or 12 cycles as measured by a push-pull test. In some embodiments, the electro-optic display disclosed herein or prepared according to the methods disclosed herein has a contrast ratio of at least 5, at least 6, at least 7, at least 8, at least 9, at least 10, at least 11, at least 12, at least 13, at least 14, at least 15, at least 16, at least 17, at least 18, at least 19, at least 20, at least 21, at least 22, at least 23, at least 24, or at least 25, at −15 °C after 2, 4, 6, 8, 10, or 12 cycles as measured by a push-pull test. In some embodiments, the electro-optic display disclosed herein or prepared according to the methods disclosed herein has a contrast ratio of at least 5, at least 6, at least 7, at least 8, at least 9, at least 10, at least 11, at least 12, at least 13, at least 14, at least 15, at least 16, at least 17, at least 18, at least 19, at least 20, at least 21, at least 22, at least 23, at least 24, or at least 25, at −10 °C after 2, 4, 6, 8, 10, or 12 cycles as measured by a push-pull test.

In some embodiments, the electro-optic display disclosed herein or prepared according to the methods disclosed herein has a white state (WS) L* of at least 50, at least 55, at least 60, at least 65, at least 70, at least 75, at least 80, at least 85, at least 90, or at least 95 at −20 °C with c*<5 after 2, 4, 6, 8, 10, or 12 cycles as measured by a push-pull test. In some embodiments, the electro-optic display disclosed herein or prepared according to the methods disclosed herein has a white state L* of at least 50, at least 55, at least 60, at least 65, at least 70, at least 75, at least 80, at least 85, at least 90, or at least 95 at −15 °C with c*<5 after 2, 4, 6, 8, 10, or 12 cycles as measured by a push-pull test. In some embodiments, the electro-optic display disclosed herein or prepared according to the methods disclosed herein has a white state L* of at least 50, at least 55, at least 60, at least 65, at least 70, at least 75, at least 80, at least 85, at least 90, or at least 95 at −10 °C with c*<5 after 2, 4, 6, 8, 10, or 12 cycles as measured by a push-pull test.

In some embodiments, the electro-optic display disclosed herein or prepared according to the methods disclosed herein has a dark state (DS) L* of less than 55, less than 50, less than 45, less than 40, less than 35, less than 30, less than 25, less than 20, less than 15, less than 10, or less than 5, at −20 °C with c*<20 after 2, 4, 6, 8, 10, or 12 cycles as measured by a push-pull test. In some embodiments, the electro-optic display disclosed herein or prepared according to the methods disclosed herein has a dark state (DS) L* of less than 55, less than 50, less than 45, less than 40, less than 35, less than 30, less than 25, less than 20, less than 15, less than 10, or less than 5, at −15 °C with c*<20 after 2, 4, 6, 8, 10, or 12 cycles as measured by a push-pull test. In some embodiments, the electro-optic display disclosed herein or prepared according to the methods disclosed herein has a dark state (DS) L* of less than 55, less than 50, less than 45, less than 40, less than 35, less than 30, less than 25, less than 20, less than 15, less than 10, or less than 5, at −10 °C with c*<20 after 2, 4, 6, 8, 10, or 12 cycles as measured by a push-pull test.

Another aspect of the present disclosure provides a method for preparing an electro-optic display. The method comprises providing a first subassembly comprising an electro-optic medium layer and a first substrate, the electro-optic medium comprising a continuous phase and a discontinuous phase; providing a second subassembly comprising a backplane electrode; and laminating the two subassemblies to one another using a first lamination adhesive so that the electro-optic medium layer is disposed between the first substrate and the backplane electrode. The discontinuous phase comprises a plurality of capsules and the continuous phase surrounds the discontinuous phase and comprises a binder, a rheology modifier, and a surfactant. The surfactant comprises a silicone polyether surfactant. Suitably, the silicone polyether surfactant may comprise a PEG/PPG-dimethicone, e.g., a PEG/PPG-18/18 dimethicone, or a PEG-dimethicone.

The first substrate may comprise a light-transmissive top electrode. The first substrate may comprise a release sheet and the method comprises laminating the first subassembly to a light-transmissive top electrode using a second lamination adhesive.

The loading amount of the surfactant may vary. In some embodiments, the dry mass weight ratio of the capsule to the surfactant is about 40:1 to about 120:1. In some embodiments, the dry mass weight ratio of the capsule to the surfactant is about 50:1 to about 110:1. In some embodiments, the dry mass weight ratio of the capsule to the surfactant is about 60:1 to about 100:1. In some embodiments, the dry mass weight ratio of the capsule to the surfactant is about 70:1 to about 90:1. In some embodiments, the dry mass weight ratio of the capsule to the surfactant is about 80:1.

Each capsule comprises at least one charged pigment particle dispersed in a hydrocarbon solvent. Each capsule may comprise two, three, four, or more than four different kinds of charged pigment particles dispersed in a hydrocarbon solvent. Each capsule may comprise at least three different kinds of charged pigment particles dispersed in a hydrocarbon solvent. Each capsule may comprise a first, a second, a third, and a fourth kind of different pigment particles. The different kinds of charged pigment particles may be characterized by color. For example, the four different kinds of pigment particles may be white, yellow, magenta, and cyan pigment particles. Other combinations of colored pigment particles may be used.

In some embodiments, a “slurry”, or an “ink slurry” of an electro-optic medium is first prepared by mixing the capsules, binder, and additives (e.g., surfactant, rheology modifier). The slurry is then coated and assembled into an electro-optic display.

### Electro-Optic Medium

The electro-optic medium may comprise a continuous phase and a discontinuous phase. In some embodiments, the discontinuous phase comprises a plurality of capsules. Each capsule may be filled with a suspending fluid comprising at least one particle dispersed in a solvent and capable of moving through the fluid upon application of an electric field to the electro-optic medium. The continuous phase surrounds and encapsulates the discontinuous phase, thus providing a cohesive electro-optic medium. The continuous phase comprises a binder, a rheology modifier, and a surfactant. The surfactant comprises a silicone polyether surfactant.

The solvent within the capsules may be of low dielectric constant (e.g., less than 10 or less than 3). In some embodiments, the solvent comprises a hydrocarbon solvent, such as heptane, octane, and petroleum distillates such as Isopar (Exxon Mobil) or Isane® (Total); terpenes such as limonene, e.g., 1-limonene; and/or aromatic hydrocarbons such as toluene. The index of refraction of the internal phase of a capsule may be modified with the addition of index matching agents such as Cargille® index matching fluids available from Cargille-Sacher Laboratories Inc. (Cedar Grove, N.J.).

The charged particles may vary in color, reflective or absorptive properties, charge density, and mobility in an electric field (measured as a zeta potential). A particle that absorbs, scatters, or reflects light, either in a broad band or at selected wavelengths, is referred to herein as a colored or pigment particle. Various materials other than pigments (in the strict sense of that term as meaning insoluble colored materials) that absorb or reflect light, such as dyes or photonic crystals, etc., may also be used in the electro-optic media and displays of the present disclosure. The electro-optic medium may comprise pigments having white, black, cyan, magenta, yellow, blue, green, red, and other colors.

The pigment particle loading amount in the suspending fluid may vary. In some embodiments, the suspending fluid may have a total charged pigment particle loading of at least 20%, at least 30%, at least 35%, at least 40%, at least 45%, at least 50%, at least 60%, or at least 70%.

The electro-optic medium may contain two types of charged particles having different colors, a first type of charged particles having a first charge polarity, and a second type of charged particles having a second charged polarity opposite to the first charged polarity. For example, the first type of charged particles may be black and the second type of charged particles may be white.

The electro-optic medium may contain three types of charged particles all having different colors, a first type of charged particles having a first charge polarity, a second type of charged particles having a second charge polarity that is opposite to the first charge polarity, and a third type of charge particles having a third charge polarity that is the same as the first or the second charge polarity. For example, the first type of charged particles may be black, the second type of charged particles may be white, and the third type of charged particles may be selected from the group consisting of red, yellow, blue, cyan, magenta, green, and orange.

In some embodiments, each capsule of the electro-optic medium comprises at least three different kinds of charged pigment particles dispersed in a hydrocarbon solvent.

The electro-optic medium may contain four types of charged particles all having different colors, a first type of charged particles having a first charge polarity, a second type of charged particles having the first charge polarity, a third type of charge particles having a second charge polarity opposite to the first charge polarity, and a fourth type of charged particles having the second charge polarity. The magnitude of the charge of the first type of particles may be higher than the magnitude of the charge of the second type of particles, and the magnitude of the charge of the third type of particles may be higher than the charge of the fourth type of particles. For example, the first type of charged particles may be cyan, the second type of charged particles may be magenta, the third type of particles may be yellow and the fourth type of charged particles may be white.

The electro-optic medium may contain four types of charged particles all having different colors, a first type of charged particles having a first charge polarity, a second type of charged particles having the first charge polarity, a third type of charge particles having the first charge polarity, and a fourth type of charged particles having a second charge polarity that is opposite to the first charge polarity. The magnitude of the charges of the first, second, and third particles may be different from each other. The magnitude of the charge of the third type of particles may be higher than the magnitude of the charge of the first type of particles that may be higher than the magnitude of the charge of the second type of particles. For example, the first type of particles may be cyan, the second type of particles may be magenta, the third type of particles may be yellow, and the fourth type of particles may be white.

In some embodiments, each capsule of the electro-optic medium comprises first, second, third, and fourth kinds of pigment particles. In some embodiments, the four kinds of pigment particles are white, yellow, magenta, and cyan.

The electro-optic medium may contain five types of charged particles all having different colors, a first type of charged particles having a first charge polarity, a second type of charged particles having the first charge polarity, a third type of particles having the first charge polarity, a fourth type of particles having a second charge polarity that is opposite to the first charge polarity, and a fifth type of particles having the second charge polarity. The magnitude of the first, second, and third charges may be different from each other. The magnitude of the charge of the third type of particles may be higher than the magnitude of the charge of the first type of particles that may be higher than the magnitude of the charge of the second type of particles. The charge of the fourth type of particles may have higher charge than the fifth type of charged particles. For one example, the first type of particles may be cyan, the second type of particles may be magenta, the third type of particles may be black, the fourth type of particles may be yellow, and the fifth type of particles may be white.

In some embodiments, the present disclosure uses a light-scattering particle, typically white, and three substantially non-light-scattering particles. There is of course no such thing as a completely light-scattering particle or a completely non-light-scattering particle, and the minimum degree of light scattering of the light-scattering particle, and the maximum tolerable degree of light scattering tolerable in the substantially non-light-scattering particles, used in the electrophoretic of the present disclosure may vary somewhat depending upon factors such as the exact pigments used, their colors and the ability of the user or application to tolerate some deviation from ideal desired colors. The scattering and absorption characteristics of a pigment may be assessed by measurement of the diffuse reflectance of a sample of the pigment dispersed in an appropriate matrix or liquid against white and dark backgrounds. Results from such measurements can be interpreted according to a number of models that are well-known in the art, for example, the one-dimensional Kubelka-Munk treatment. In the present disclosure, it is preferred that the white pigment exhibit a diffuse reflectance at 550 nm, measured over a black background, of at least 5% when the pigment is approximately isotropically distributed at 15% by volume in a layer of thickness 1 μm comprising the pigment and a liquid of refractive index less than 1.55. The yellow, magenta and cyan pigments preferably exhibit diffuse reflectances at 650, 650 and 450 nm, respectively, measured over a black background, of less than 2.5% under the same conditions. (The wavelengths chosen above for measurement of the yellow, magenta and cyan pigments correspond to spectral regions of minimal absorption by these pigments.) Colored pigments meeting these criteria are hereinafter referred to as “non-scattering” or “substantially non-light-scattering”. Specific examples of suitable particles are disclosed in U.S. Pat. No. 9,921,451, which is incorporated by reference herein.

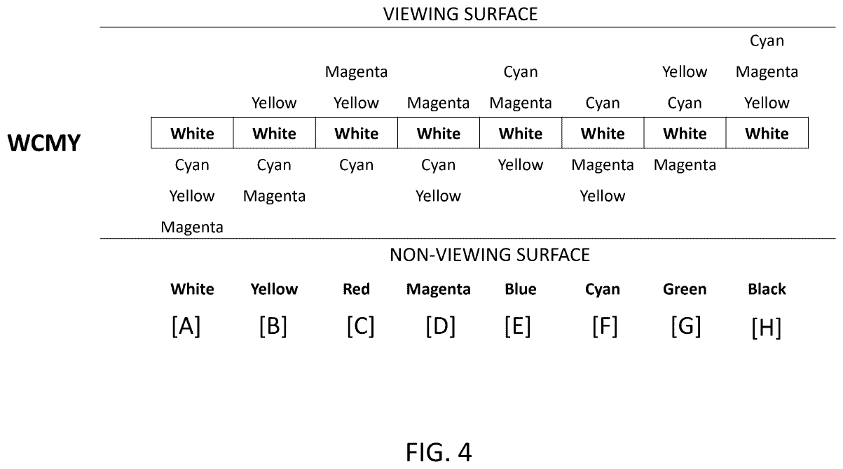

As shown in FIG. 4, in the instance of a four-particle system including subtractive cyan, yellow, and magenta particles paired with a reflective white particle, each of the eight principal colors (red, green, blue, cyan magenta, yellow, black and white) corresponds to a different arrangement of the four pigments. The three particles providing the three subtractive primary colors, e.g., for an Advanced Color electronic Paper (ACeP) display, may be substantially non-light-scattering (“SNLS”). The use of SNLS particles allows mixing of colors and provides for more color outcomes than can be achieved with the same number of scattering particles. These thresholds must be sufficiently separated relative to the voltage driving levels for avoidance of cross-talk between particles, and this separation necessitates the use of high addressing voltages for some colors. In addition, addressing the colored particle with the highest threshold also moves all the other colored particles, and these other particles must subsequently be switched to their desired positions at lower voltages.

The system of FIG. 4, in principle, works similar to printing on bright white paper in that the viewer only sees those colored pigments that are on the viewing side of the white pigment (i.e., the only pigment that scatters light). In FIG. 4, it is assumed that the viewing surface of the display is at the top (as illustrated), i.e., a user views the display from this direction, and light is incident from this direction. As already noted, in preferred embodiments only one of the four particles used in the electro-optic medium of the present disclosure substantially scatters light, and in FIG. 4 this particle is assumed to be the white pigment. This light-scattering white particle forms a white reflector against which any particles above the white particles (as illustrated in FIG. 4) are viewed. Light entering the viewing surface of the display passes through these particles, is reflected from the white particles, passes back through these particles and emerges from the display. Thus, the particles above the white particles may absorb various colors and the color appearing to the user is that resulting from the combination of particles above the white particles. Any particles disposed below (behind from the user's point of view) the white particles are masked by the white particles and do not affect the color displayed. Because the second, third and fourth particles are substantially non-light-scattering, their order or arrangement relative to each other is unimportant, but for reasons already stated, their order or arrangement with respect to the white (light-scattering) particles is critical.

More specifically, when the cyan, magenta and yellow particles lie below the white particles (Situation [A] in FIG. 4), there are no particles above the white particles and the pixel simply displays a white color. When a single particle is above the white particles, the color of that single particle is displayed, yellow, magenta and cyan in Situations [B], [D] and [F] respectively in FIG. 4. When two particles lie above the white particles, the color displayed is a combination of these two particles; in FIG. 4, in Situation [C], magenta and yellow particles display a red color, in Situation [E], cyan and magenta particles display a blue color, and in Situation [G], yellow and cyan particles display a green color. Finally, when all three colored particles lie above the white particles (Situation [H] in FIG. 4), all the incoming light is absorbed by the three subtractive primary colored particles and the pixel displays a black color. Because the order of the particles between the pixel electrode and viewer is critical, a pixel electrode that is not updated during a partial update can be disturbed by a neighboring pixel that is being updated. Furthermore, the resulting color shift may not be predictable because the highest charged particles, typically cyan, move the most due to inter-pixel coupling.

As applied to the particle set illustrated in FIG. 4, producing eight independent primary colors refers to switching between white, yellow, red, magenta, blue, cyan, green, and black (Situations [A]-[H], respectively). The independent primary colors may be switched in any order. The time to produce all eight independent primary colors may be determined by detecting each of the eight independent primary colors or by detecting two (e.g., white and black) or more independent primary colors and approximating the time two switch between each of the eight independent primary colors.

Additionally, the charged pigment particles may be functionalized with surface polymers to improve state stability. Such pigments are described in U.S. Pat. No. 9,921,451, which is incorporated by reference in its entirety.

Encapsulation of the internal phase of the capsules may be accomplished in a number of different ways. Numerous suitable procedures for microencapsulation are detailed in both Microencapsulation, Processes and Applications, (I. E. Vandegaer, ed.), Plenum Press, New York, N.Y. (1974) and Gutcho, Microcapsules and Mircroencapsulation Techniques, Nuyes Data Corp., Park Ridge, N.J. (1976), both of which are hereby incorporated by reference herein. The processes fall into several general categories, all of which can be applied to the present disclosure: interfacial polymerization, in situ polymerization, physical processes, such as coextrusion and other phase separation processes, in-liquid curing, and simple/complex coacervation.

Numerous materials and processes may prove useful in formulating displays of the present disclosure. Useful materials for simple coacervation processes include, but are not limited to, gelatin, polyvinyl alcohol, polyvinyl acetate, and cellulosic derivatives, such as, for example, carboxymethylcellulose. Useful materials for complex coacervation processes include, but are not limited to, gelatin, acacia, carageenan, carboxymethylcellulose, hydrolized styrene anhydride copolymers, agar, alginate, casein, albumin, methyl vinyl ether co-maleic anhydride, and cellulose phthalate. Useful materials for phase separation processes include, but are not limited to, polystyrene, PMMA, polyethyl methacrylate, polybutyl methacrylate, ethyl cellulose, polyvinyl pyridine, and poly acrylonitrile. Useful materials for in situ polymerization processes include, but are not limited to, polyhydroxyamides, with aldehydes, melamine, or urea and formaldehyde; water-soluble oligomers of the condensate of melamine, or urea and formaldehyde; and vinyl monomers, such as, for example, styrene, MMA and acrylonitrile. Finally, useful materials for interfacial polymerization processes include, but are not limited to, diacyl chlorides, such as, for example, sebacoyl, adipoyl, and di- or poly-amines or alcohols, and isocyanates. Useful emulsion polymerization materials may include, but are not limited to, styrene, vinyl acetate, acrylic acid, butyl acrylate, t-butyl acrylate, methyl methacrylate, and butyl methacrylate.

In some embodiments, the capsules may comprise gelatin-based capsule walls. The gelatin is available from various commercial suppliers, such as Sigma Aldrich or Gelitia USA. It can be obtained in a variety of grades and purity depending upon the needs of the application. Gelatin primarily comprises collagen that has been collected from animal products (cow, pig, poultry, fish) and hydrolyzed. It comprises a mixture of peptides and proteins. In some embodiments, the gelatin is combined with acacia (gum arabic), which is derived from the hardened sap of the acacia tree. Acacia is a complex mixture of glycoproteins and polysaccharides, and it is often used as a stabilizer in food stuffs. Aqueous solutions of acacia and gelatin can be coacervated with a non-polar internal phase to produce clear and flexible capsules containing internal phase.

Capsules incorporating gelatin/acacia may be prepared following known methods; see, for example, U.S. Pat. Nos. 7,170,670 and 6,067,185, incorporated by reference in their entireties. In some embodiments, an aqueous mixture of gelatin and acacia is emulsified with a hydrocarbon internal phase (or other water-immiscible phase) to encapsulate the internal phase. The mixture is heated and the pH lowered to form a gelatin/acacia coacervate, thereby forming capsules. The temperature of the resultant mixture is then lowered and a solution of cross-linking agents is added. The resultant mixture is then warmed and stirred vigorously. A finishing step (holding the capsule mixture at 50 C for about one hour) is used to deactivate the remaining cross-linking agents, thereby assuring that the capsules will separate during sieving. The process yields capsules in the range of 20-100 M and often incorporates over 50 percent of the starting materials into useable capsules. The capsules produced are then separated by size by sieving or other size exclusion sorting. After size sorting, the capsules are mixed with the binder to create a slurry for coating, e.g., using slot coating, knife coating, spin coating, etc.

The electro-optic medium of the present disclosure may contain any of the additives used in prior art electro-optic media as described, for example in applications mentioned above. Thus, for example, the electro-optic medium of the present disclosure may comprise a charge control agent (CCA) to control the charge on the various particles. Suitable charge control agents include quaternized vegetable oils and other unsaturated hydrocarbons, such as described in U.S. Pat. No. 11,098,206, which is incorporated by reference in its entirety.

In some embodiments, the electro-optic medium comprises a surfactant. Surfactants have been used for some time with electro-optic media to improve the performance of the electro-optic display. The surfactant may be of any type, such as an anionic surfactant, a cationic surfactant, a nonionic surfactant, an amphoteric surfactant, a zwitterionic surfactant, or a combination thereof. Surfactants tend to lower the surface tension between two liquids (interfacial tension). The surfactant may contain both one or more hydrophobic functional groups and one or more hydrophilic functional groups.

The surfactant comprises a silicone polyether surfactant. The silicone polyether surfactant may be nonionic surfactant. The surfactant contains a linear-chain backbone and one or more side branches. The surfactant contains a water-insoluble silicone backbone and one or more water-soluble polyether pendant groups. The ratio of the silicone to polyether as well as the molecular weight and composition of the components may be selected to alter the solubility and specific properties of the surfactant. The surfactant may be multi-pendant polymer or a linear di-functional polymer. For example, the silicone polyether surfactant may have formula of (R¹)₃Si—[OSi(R¹)₂]ₘ—[OSi(R¹)(R²)]ₙ—OSi(R¹)₃ or (R¹)₂(R²)Si—[OSi(R¹)₂]ₘ—OSi(R¹)₂(R²) where R¹ is an alkyl, such as methyl, R² is a polyether group, and m and n are integers from 2 to 30, preferably from 5 to 20. The polyether group R² may be comprised of polyethylene glycol (PEG) and/or polypropylene glycol (PPG) groups. R² may optionally comprise an alkylene group. Suitably, R² may comprise —[CH₂]ᵢ—[OCH₂CH₂]ⱼ—[[OCH₂CH(CH₃)]ₖ. Each of i, j, and k are integers from 0 to 20, preferably from 2 to 6. In some embodiments, the surfactant is water soluble. In some embodiments, the surfactant is water soluble and has a hydrophilic-lipophilic balance (HLB) value of at least 10. For example, the surfactant may have a HLB value between 10 and 15, 10 and 14, 10 and 13, 10 and 12, or 10 and 11. Suitable surfactants include, but are not limited to, XIAMETER™ OFX-5098, VORASURF™ DC5103, SYLGARD™ OFX-0309, XIAMETER™ OFX-5211, DOWSIL™ 57, DOWSIL™ 55, and Silsurf® CR 1115. In some embodiments, the silicone polyether surfactant comprises a PEG/PPG-dimethicone, e.g., a PEG/PPG-18/18 dimethicone, or a PEG-dimethicone. The surfactant may contribute to improved contrast ratio of the electro-optic display. The surfactant may contribute to improved contrast ratio of the electro-optic display at low temperatures.

The loading amount of the surfactant may vary. In some embodiments, the dry mass weight ratio of the capsule to the surfactant is about 40:1 to about 120:1. In some embodiments, the dry mass weight ratio of the capsule to the surfactant is about 50:1 to about 110:1. In some embodiments, the dry mass weight ratio of the capsule to the surfactant is about 60:1 to about 100:1. In some embodiments, the dry mass weight ratio of the capsule to the surfactant is about 70:1 to about 90:1. In some embodiments, the dry mass weight ratio of the capsule to the surfactant is about 80:1. The “dry mass weight ratio” disclosed herein is calculated using the dry mass weight of the total amount of the capsules and the total amount of the surfactant in the electro-optic display.

In some embodiments, the electro-optic medium comprises a rheology modifier. Rheology modifiers are compounds, typically polymeric materials, which adjust the rheology, such as viscosity, of the medium to the desired value. In some embodiment, the rheology modifier comprises hydroxypropyl methyl cellulose (HPMC).

In some embodiments, the electro-optic medium comprises a depleter. In some embodiments, depleters may be utilized to maintain image stability of the electro-optic display when no electric field is applied. Suitable depleters include, but are not limited to, polyisobutylene, polylauryl methacrylate, polystyrene, and polydimethylsiloxane (PDMS). In some embodiments, the depleter comprises polydimethylsiloxane (PDMS).

In some embodiments, the electro-optic medium comprises a dopant, for example, (a) a salt, a polyelectrolyte, a polymer electrolyte, a solid electrolyte, and combinations thereof, or (b) a non-reactive solvent, a conductive organic compound, or combinations thereof. For example, the dopant may be a salt such as an inorganic salt, organic salt, or combination thereof, as described in U.S. Pat. No. 7,012,735, incorporated by reference in its entirety.

The electro-optic media disclosed herein may be incorporated into electro-optic displays and assemblies disclosed herein, or may be adopted in methods for preparing electro-optic displays disclosed herein.

In some embodiments, electro-optic displays comprising the electro-optic medium compositions having the silicone polyether surfactant display higher WS L* comparing to electro-optic displays comprising alternative electro-optic medium compositions at low temperatures, such as at −20 °C. In some embodiments, electro-optic displays comprising the electro-optic medium compositions having the silicone polyether surfactant display lower DS L* comparing to electro-optic displays comprising alternative electro-optic medium compositions at low temperatures, such as at −20 °C. In some embodiments, electro-optic displays comprising the electro-optic medium compositions having the silicone polyether surfactant display improved CR comparing to electro-optic displays comprising alternative electro-optic medium compositions at low temperatures, such as at −20 °C.

### Driving the Device

For the most part, electro-optic media, such as described above, are designed to be driven with low voltage square waves, such as produced by a driver circuit using a thin-film-transistor backplane. Such driver circuits can be inexpensively mass-produced because they are very closely related to the driving circuitry and fabrication methods that are used to produce liquid crystal display panels, such as found in smart phones, laptop monitors, and televisions. Historically, even when electro-optic media are driven directly via an isolated electrode (e.g., segmented electrode) the driving pulses are delivered as square waves, having an amplitude and a time width. See, for example, U.S. Pat. No. 7,012,600, incorporated by reference in its entirety. Typically, for an active matrix backplane including an array of pixel electrodes, each pixel electrode will receive a signal pulse (square wave) for a short period of time as the array of pixel electrodes are addressed in a line-by-line fashion. The period of time that it takes to update the entire array of pixels, and also the time between updates of an individual pixel electrode is known as a frame. The collection of voltage impulses required to change the display from a first display state to a second state is generally known as a waveform. A waveform typically includes at least three frames, e.g., as described in U.S. Pat. No. 11,620,959, which is incorporated by reference in its entirety.

Electro-optic displays typically have a backplane provided with a plurality of pixel electrodes each of which defines one pixel of the display. Each pixel electrode is typically disposed in a rectangular array of pixel electrodes and each pixel electrode is controlled with a thin-film transistor (TFT), and the TFTs are updated in a row-by-row fashion. Conventionally, a single common electrode extends over a large number of pixels, and normally the whole display is provided on the opposed side of the electro-optic medium. The single common electrode is coupled to the backplane via an isolated electrical connection, a.k.a., a “top plane connection.” The individual pixel electrodes may be driven directly (i.e., a separate conductor may be provided to each pixel electrode) or the pixel electrodes may be driven in an active matrix manner which will be familiar to those skilled in backplane technology. Since adjacent pixel electrodes will often be at different voltages, they must be separated by inter-pixel gaps of finite width in order to avoid electrical shorting between electrodes. Although at first glance it might appear that the electro-optic medium overlying these gaps would not switch when drive voltages are applied to the pixel electrodes (and indeed, this is often the case with some non-bistable electro-optic media, such as liquid crystals, where a black mask is typically provided to hide these non-switching gaps), in the case of many bistable electro-optic media the medium overlying the gap does switch because of a phenomenon known as “blooming”.

Blooming refers to the tendency for application of a drive voltage to a pixel electrode to cause a change in the optical state of the electro-optic medium over an area larger than the physical size of the pixel electrode. An area of blooming is not a uniform color, but is typically a transition zone where, as one moves across the area of blooming, the color of the medium transitions from the desired color to another shade or color, for example a desired white pixel may include various shades of gray along the edges, a.k.a., “edge ghosting”. Furthermore, depending upon the type of display, i.e., black/white, color, black/white with color filter, the results of the edge ghosting can range from annoying to debilitating. In some cases, asymmetric blooming may contribute to edge ghosting.

The terms bistable and bistability are used herein in their conventional meaning in the art to refer to displays comprising display elements having first and second display states differing in at least one optical property, and such that after any given element has been driven, by means of an addressing pulse of finite duration, to assume either its first or second display state, after the addressing pulse has terminated, that state will persist for at least several times, for example at least four times, the minimum duration of the addressing pulse required to change the state of the display element. It is shown in U.S. Pat. No. 7,170,670 that some particle-based electrophoretic displays capable of gray scale are stable not only in their extreme black and white states but also in their intermediate gray states, and the same is true of some other types of electro-optic displays. This type of display is properly called multi-stable rather than bistable, although for convenience the term bistable may be used herein to cover both bistable and multi-stable displays. While the bistable nature of electrophoretic displays allows for massive power savings over traditional “always on” displays such as LCD and LED, the bistability can lead to image retention between updates, e.g., “ghosts” or “image sticking”.

The term impulse, when used to refer to driving an electro-optic display, is used herein to refer to the integral of the applied voltage with respect to time during the period in which the display is driven. The term waveform, when used to refer to driving an electro-optic display is used to describe a series or pattern of voltages provided to an electro-optic medium over a given time period (seconds, frames, etc.) to produce a desired optical effect in the electro-optic medium.

Waveforms for driving four-particle electro-optic media have been described previously. Waveforms for driving color electro-optic displays having four particles are described in U.S. Pat. Nos. 9,921,451, 9,812,073, and 11,640,803, all of which are incorporated by reference herein. Most commercial electro-optic displays use amorphous silicon based thin-film transistors (TFTs) in the construction of active matrix backplanes (260) because of the wider availability of fabrication facilities and the costs of the various starting materials. Amorphous silicon thin-film transistors may become unstable when supplied gate voltages that would allow switching of voltages higher than about +/−15V, e.g., e.g., +/−24V, or +/−30V. Accordingly, as described in previous patents/applications on such systems, improved performance is achieved by additionally changing the bias of the top light-transmissive electrode with respect to the bias on the backplane pixel electrodes, a technique known as top-plane switching. Thus, if a voltage of +30V (relative to the backplane) is needed, the top plane may be switched to −15V while the appropriate backplane pixel is switched to +15V. Methods for driving a four-particle electro-optic system with top-plane switching are described in greater detail in, for example, U.S. Pat. No. 9,921,451. In alternative embodiments, metal oxide semiconductors may be incorporated into thin film transistors for active matrix backplanes (260), including IGZO, i.e., as described in U.S. Pat. No. 11,776,496, which is incorporated by reference in its entirety.

In some embodiments, the electro-optic display may include only a first light-transmissive electrode, an electro-optic medium, and a second (rear) electrode, which may also be light-transmissive. However, to produce a high-resolution display, each pixel must be addressable without interference from adjacent pixels so that an image file is faithfully reproduced in the display. One way to achieve this objective is to provide an array of non-linear elements, such as transistors or diodes, with at least one non-linear element associated with each pixel, to produce an “active matrix” display. An addressing or pixel electrode, which addresses one pixel, is connected to an appropriate voltage source through the associated non-linear element. Typically, when the non-linear element is a transistor, the pixel electrode is connected to the drain of the transistor, and this arrangement will be assumed in the following description, although it is essentially arbitrary and the pixel electrode could be connected to the source of the transistor. Conventionally, in high resolution arrays, the pixels are arranged in a two-dimensional array of rows and columns, such that any specific pixel is uniquely defined by the intersection of one specified row and one specified column. The sources of all the transistors in each column are connected to a single column electrode, while the gates of all the transistors in each row are connected to a single row electrode; again the assignment of sources to rows and gates to columns is conventional but essentially arbitrary, and could be reversed if desired. The row electrodes are connected to a row driver, which essentially ensures that at any given moment only one row is selected, i.e., that there is applied to the selected row electrode a select voltage such as to ensure that all the transistors in the selected row are conductive, while there is applied to all other rows a non-select voltage such as to ensure that all the transistors in these non-selected rows remain non-conductive. The column electrodes are connected to column drivers, which place upon the various column electrodes voltages selected to drive the pixels in the selected row to their desired optical states. (The aforementioned voltages are relative to a common front electrode which is conventionally provided on the opposed side of the electro-optic medium from the non-linear array and extends across the whole display.)

After a pre-selected interval known as the “line address time” the selected row is deselected, the next row is selected, and the voltages on the column drivers are changed so that the next line of the display is written. This process is repeated so that the entire display is written in a row-by-row manner. The entire process is coordinated with a clock circuit. The time between addressing a pixel for the nth time and the following addressing, n+1, is known as a “frame.” Thus, a display that is updated at 60 Hz has frames that are 16 msec. “Frames” are not limited to use with an active matrix backplane, however. The driving frames described herein can also be used to refer to a unit of time between updates of, e.g., a singular backplane. While it is possible to drive electro-optic media with an analog voltage signal, such as produced by a power supply and a potentiometer, the use of a digital controller discretizes the waveform into blocks that are typically on the order of 10 ms, however shorter or longer framewidths are possible.

In a conventional electro-optic display using an active matrix backplane, each pixel electrode has associated therewith a capacitor electrode (storage capacitor) such that the pixel electrode and the capacitor electrode form a capacitor; see, for example, International Patent Publication WO 01/07961. In some embodiments, N-type semiconductor (e.g., amorphous silicon) may be used to from the transistors and the “select” and “non-select” voltages applied to the gate electrodes can be positive and negative, respectively.

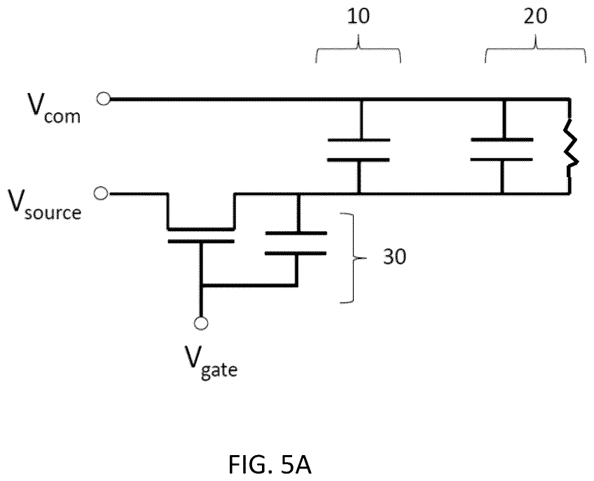

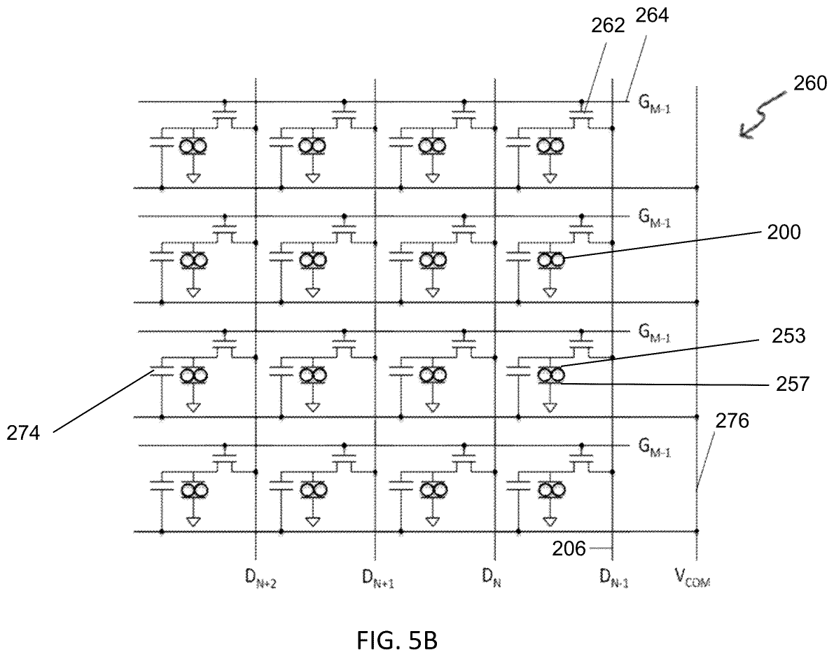

FIG. 5A depicts an exemplary equivalent circuit of a single pixel of an electro-optic display. As illustrated, the circuit includes a capacitor 10 formed between a pixel electrode and a capacitor electrode. The electro-optic medium 20 is represented as a capacitor and a resistor in parallel. In some instances, direct or indirect coupling capacitance 30 between the gate electrode of the transistor associated with the pixel and the pixel electrode (usually referred to a as a “parasitic capacitance”) may create unwanted noise to the display. Usually, the parasitic capacitance 30 is much smaller than that of the storage capacitor 10, and when the pixel rows of a display is being selected or deselected, the parasitic capacitance 30 may result in a small negative offset voltage to the pixel electrode, also known as a “kickback voltage”, which is usually less than 2 volts.

In some embodiments, the TFT array forms an active matrix 260 for image driving, as shown in FIG. 5B. For example, each pixel electrode 253 (corresponding to 130 in FIG. 1) is coupled to a thin-film transistor 262 patterned into an array, and connected to gate (row) driver lines 264 and source (column) driver lines 206, running at right angles to the gate drive lines 264. Also, typically, the common (top) light-transparent electrode 257 (corresponding to 110 in FIG. 1) has the form of a single continuous electrode while the other electrode or electrode layer is patterned into a matrix of pixel electrodes 253, each of which defines one pixel of the display. Between the pixel electrode 253 and the common electrode 257, an electro-optic medium 200 can be disposed. A source driver (not shown) is connected to the source driver lines 206 and provides source voltage to all TFTs 262 in a column that are to be addressed. A gate driver (not shown) is connected to the gate driver lines 264 to provide a bias voltage that will open (or close) the gates of each TFT 262 along the row. Each pixel of the active matrix 260 also includes a storage capacitor 274 as discussed above with respect to FIG. 5A. The storage capacitors 274 may be coupled to a common potential (V_{com}) line 276.

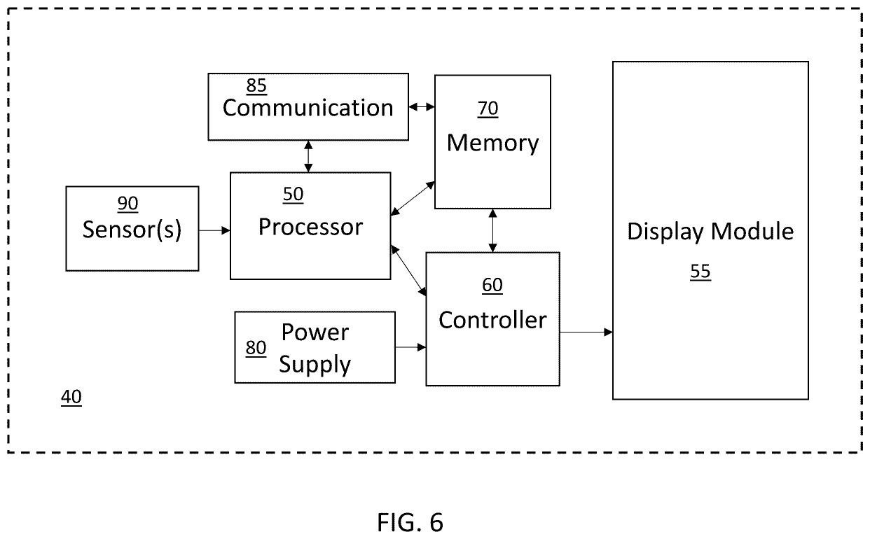

The active matrix 260 described with respect to FIG. 5B (i.e., including the electro-optic medium 200 and the common light-transparent electrode 257) is typically covered by a protective sheet (e.g., integrated barrier) and sealed to create a display module 55, as shown in FIG. 6. Such a display module 55 becomes the focus of an electro-optic display 40. The electro-optic display 40 will typically include a processor 50, which is configured to coordinate the many functions relating to displaying content on the display module 55, and to transform “standard” images, such as sRGB images to a color regime that best duplicates the image on the display module 55. As controller 60 architecture advances, more of the image processing can be embedded into the controller 60 such that an advanced controller can be incorporated into the same package as the display module 55 and pre-programmed with the tools needed to identify pixel electrodes that are at risk of blooming during a partial update. Advanced controllers for electro-optic displays are available from ULTRACHIP and NEXTRONIX.

### Miscellaneous

Unless otherwise specified or indicated by context, the terms “a”, “an”, and “the” mean “one or more.” For example, “a molecule” should be interpreted to mean “one or more molecules.”

As used herein, “about”, “approximately,” “substantially,” and “significantly” will be understood by persons of ordinary skill in the art and will vary to some extent on the context in which they are used. If there are uses of the term which are not clear to persons of ordinary skill in the art given the context in which it is used, “about” and “approximately” will mean plus or minus ≤10% of the particular term and “substantially” and “significantly” will mean plus or minus >10% of the particular term.

As used herein, the terms “include” and “including” have the same meaning as the terms “comprise” and “comprising.” The terms “comprise” and “comprising” should be interpreted as being “open” transitional terms that permit the inclusion of additional components further to those components recited in the claims. The terms “consist” and “consisting of” should be interpreted as being “closed” transitional terms that do not permit the inclusion additional components other than the components recited in the claims. The term “consisting essentially of” should be interpreted to be partially closed and allowing the inclusion only of additional components that do not fundamentally alter the nature of the claimed subject matter.

The phrase “such as” should be interpreted as “for example, including.” Moreover the use of any and all exemplary language, including but not limited to “such as”, is intended merely to better illuminate the invention and does not pose a limitation on the scope of the invention unless otherwise claimed.

Furthermore, in those instances where a convention analogous to “at least one of A, B and C, etc.” is used, in general such a construction is intended in the sense of one having ordinary skill in the art would understand the convention (e.g., “a system having at least one of A, B and C” would include but not be limited to systems that have A alone, B alone, C alone, A and B together, A and C together, B and C together, and/or A, B, and C together). It will be further understood by those within the art that virtually any disjunctive word and/or phrase presenting two or more alternative terms, whether in the description or figures, should be understood to contemplate the possibilities of including one of the terms, either of the terms, or both terms. For example, the phrase “A or B” will be understood to include the possibilities of “A” or ‘B or “A and B.”

All language such as “up to,” “at least,” “greater than,” “less than,” and the like, include the number recited and refer to ranges which can subsequently be broken down into ranges and subranges. A range includes each individual member. Thus, for example, a group having 1-3 members refers to groups having 1, 2, or 3 members. Similarly, a group having 6 members refers to groups having 1, 2, 3, 4, or 6 members, and so forth.

The modal verb “may” refers to the preferred use or selection of one or more options or choices among the several described embodiments or features contained within the same. Where no options or choices are disclosed regarding a particular embodiment or feature contained in the same, the modal verb “may” refers to an affirmative act regarding how to make or use and aspect of a described embodiment or feature contained in the same, or a definitive decision to use a specific skill regarding a described embodiment or feature contained in the same. In this latter context, the modal verb “may” has the same meaning and connotation as the auxiliary verb “can.”

All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

All references, including publications, patent applications, and patents, cited herein are hereby incorporated by reference to the same extent as if each reference were individually and specifically indicated to be incorporated by reference and were set forth in its entirety herein.

Preferred aspects of this invention are described herein, including the best mode known to the inventors for carrying out the invention. Variations of those preferred aspects may become apparent to those of ordinary skill in the art upon reading the foregoing description. The inventors expect a person having ordinary skill in the art to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

### Examples

### 1. Preparation of Internal Phase (IP) Solutions

The MCC (Micro Capsule Color) IP dispersion contains: a dispersion containing white pigment, a dispersion containing magenta pigment, a dispersion containing cyan pigment, a dispersion containing yellow pigment, a solution containing charge control agent (CCA111), a solution containing depleter (polydimethylsilane (PDMS)), a solution containing light stabilizing agent, and Isopar E as dispersion solvent. The IP dispersion was mixed thoroughly at least overnight on the roll-mill before use.

### 2. Microcapsule Encapsulation

The IP dispersion was encapsulated within gelatin and acacia microcapsules according to previously described methods. See, for example, U.S. Pat. Nos. 7,170,670 and 6,067,185, incorporated by reference in their entireties. The mean capsule size (volume %) was 57 μm.

### 3. Slurry Preparation

A slurry was prepared comprised of a silicone polyether (e.g., Silsurf® CR 1115) that contains both a water-insoluble silicone backbone and a number of water-soluble polyether pendant groups.

Silsurf® CR 1115 (i.e., PEG/PPG-18/18 dimethicone) silicone polyether surfactant was dissolved in DI water to make a 10% solution. After removing the excess water, the microcapsules were mixed with a binder (VRB-DF), hydroxypropyl methylcellulose (HPMC), and Silsurf® CR 1115. The weight ratios (dry mass) of each component are: capsule/VRB-DF=15, Capsule/HPMC=145, Capsule/surfactant=80. The resulting slurry solution was mixed on the roll-mill overnight before coating.

### 4. Assembly of Display Device

An electro-optic display panel was assembled with a UV-cured polyurethane adhesive and a 3-layer structure according to known methods. See, for example, U.S. Pat. Nos. 6,982,178 and 6,067,185, incorporated by reference in their entireties.

### 5. Electrical-Optical Properties Characterization

The low temperature CRs were measured with a laboratory controller using Push-Pull (PPS) waveforms, such as described in U.S. Pat. No. 11,620,959, incorporated by reference in its entirety. For control and sample with Silsurf® CR 1115, test glasses (TGs) were switched to yellow or blue color at room temperature (RT). Test glasses include 1.5″×1.5″ stacks of electro-optic medium sandwiched between a graphite back electrode and a piece of ITO-coated glass (top electrode). The test glasses are sealed with exposed leads which can be connected to a driver. The samples were then loaded on the controller, and the chamber temperature were reduced to −20 °C. Electro-optic (EO) performances of test glasses at −20 °C were measured for multiple cycles (at least 8) with PPS.

### Results and Discussion

### Sample Information

TABLE 1
Sample information

| | | Capsule to | | | |
|---|---|---|---|---|---|
| | | Surfactant | Slurry | Release | Starting |
| Sample # | Description | Ratio | pH | Film | Color |
| 1471-82A-1 | Control | NA | 7.12 | VLT 55% | Yellow |
| | | | | 6037 | Blue |
| 1471-82B-1 | Linear | 80 | 7.12 | VLT 55% | Yellow |
| | CR1115 | | | 6037 | Blue |

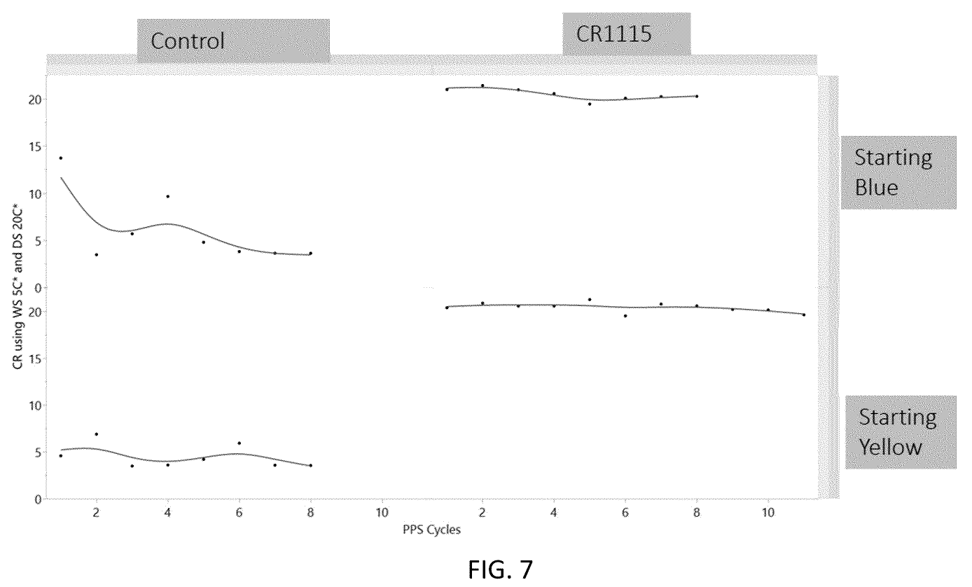

As shown in Table 1, two TGs were measured at −20 °C with a laboratory controller. Sample A is the control MCC sample with no surfactants, and sample B is an MCC sample with Silsurf® CR 1115 added into the slurry. Previously, it was speculated the starting optical state of the TG may be influential to the CR values at low temperature range. In order to rule out the possible effects of different starting colors, the TGs were switched to two MCC rail state colors, yellow and blue, separately, before collecting the EO data. The results were then analyzed by the automated EO lab data pipeline. The CR values were shown in FIG. 7.

### Comparing Contrast Ratio (CR) at −20 °C

As demonstrated in FIG. 7, the CR values of control samples were stabilized around 5, and the starting state (yellow or blue) did not show any obvious influence on the CR values. For the sample with Silsurf® CR 1115 silicone surfactant, the CR values at −20 °C were around 20. Similarly, the starting state, yellow or blue, did not demonstrate any notable impact on the low temperature CR values of the sample with silicone surfactant.

### Comparing White State and Dark State L* at −20 °C

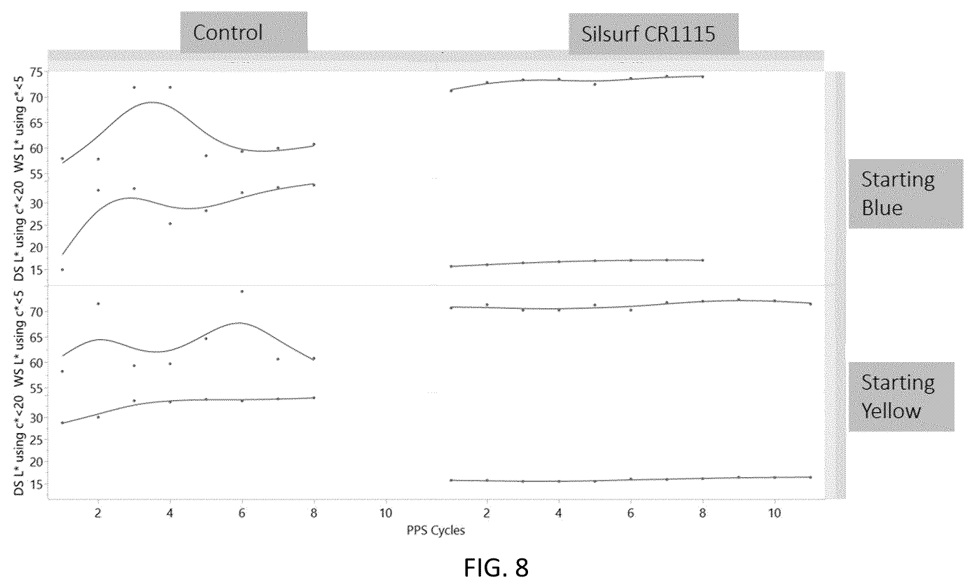

The CR values are closely related to the DS L* and WS L* of the TG. As shown in FIG. 8, introducing Silsurf® CR 1115 into MCC slurry lowered the DS L* (using c*<20) values and increased the WS L* (using c*<5). This results in better dark state and better white state quality for the MCC samples. With better DS L* and WS L*, the CR of silicone surfactant samples was improved in comparison to the control. An additional advantage realized by adding the silicone surfactants was a reduction in the variance between each PPS cycle.

### Comparing L*C* Plots at −20 °C

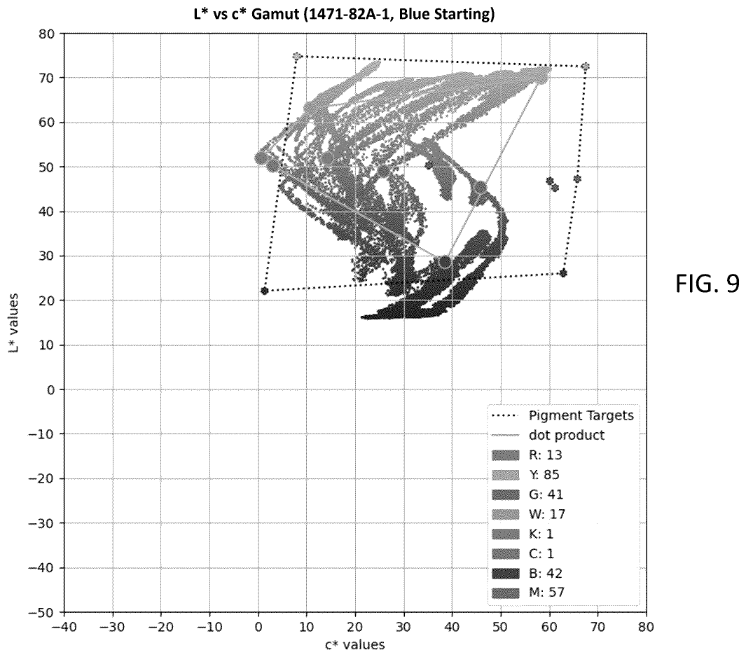

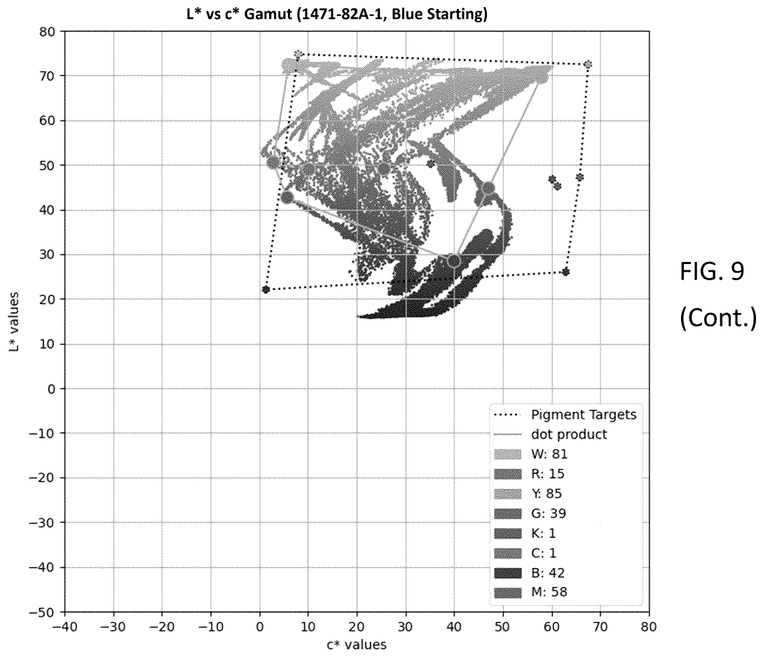

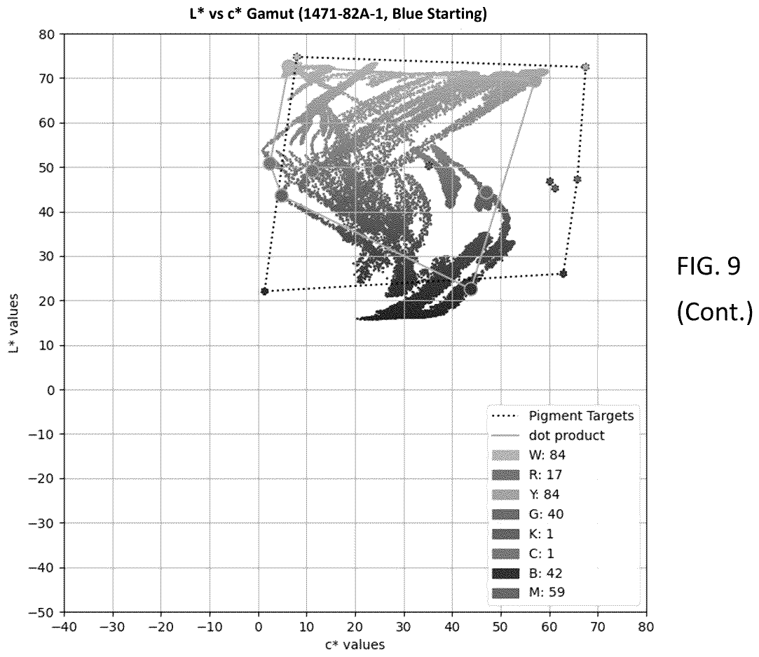

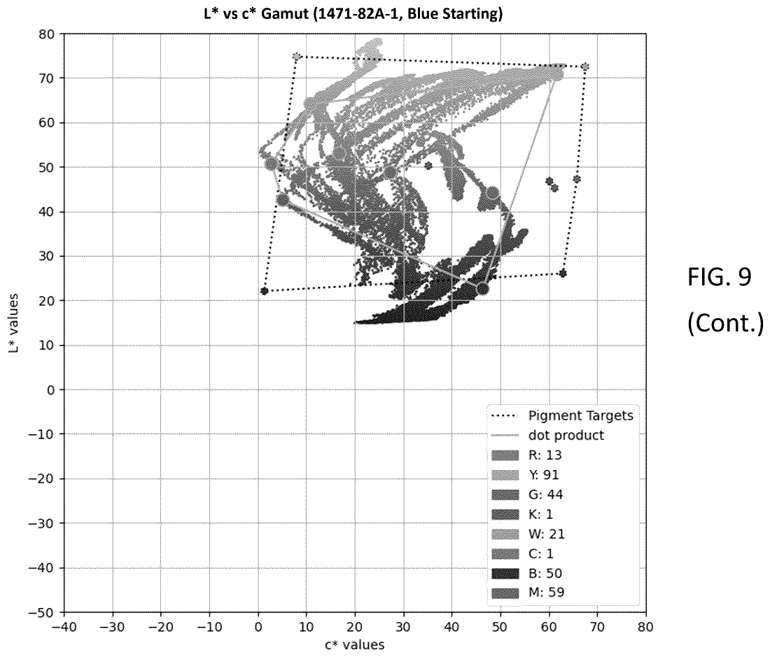

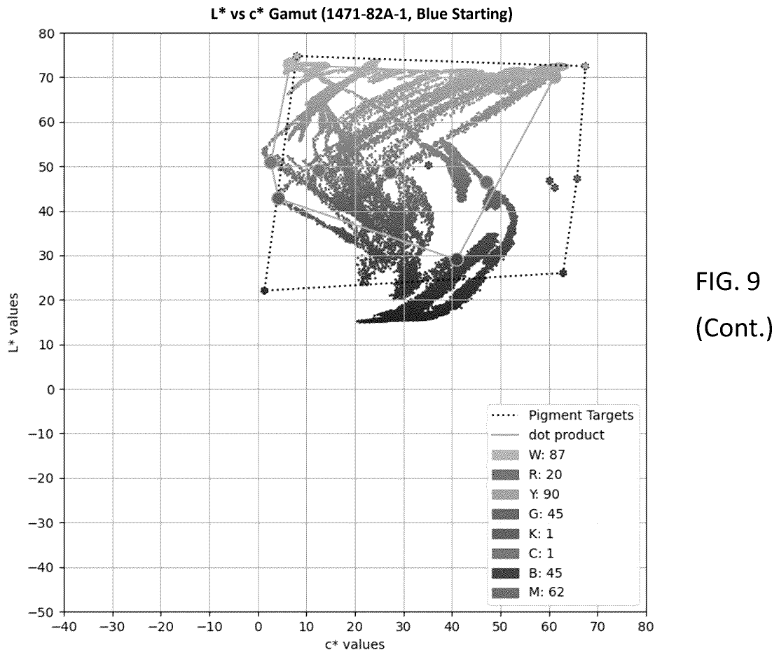

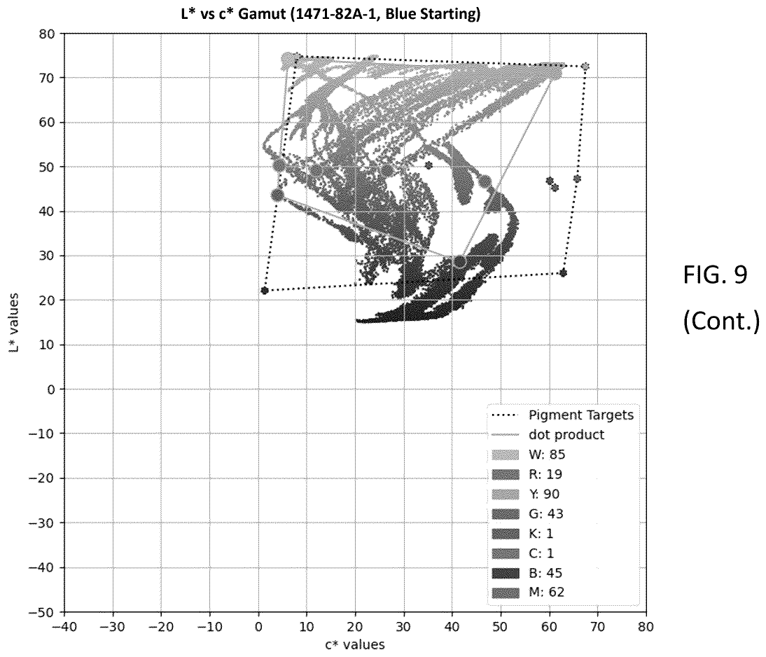

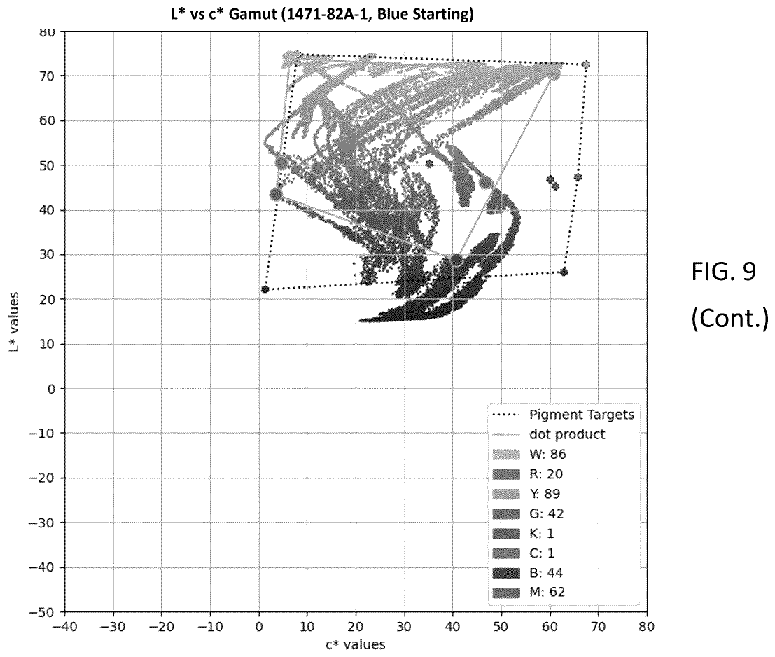

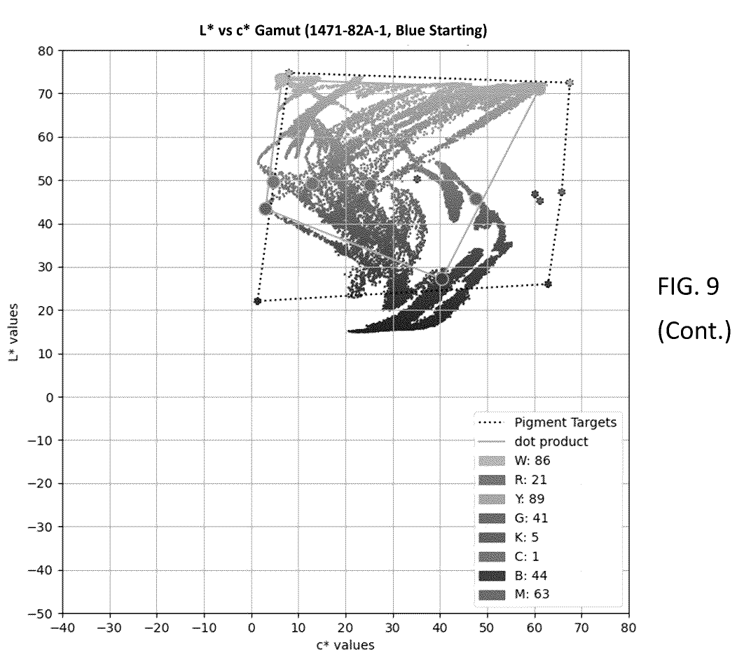

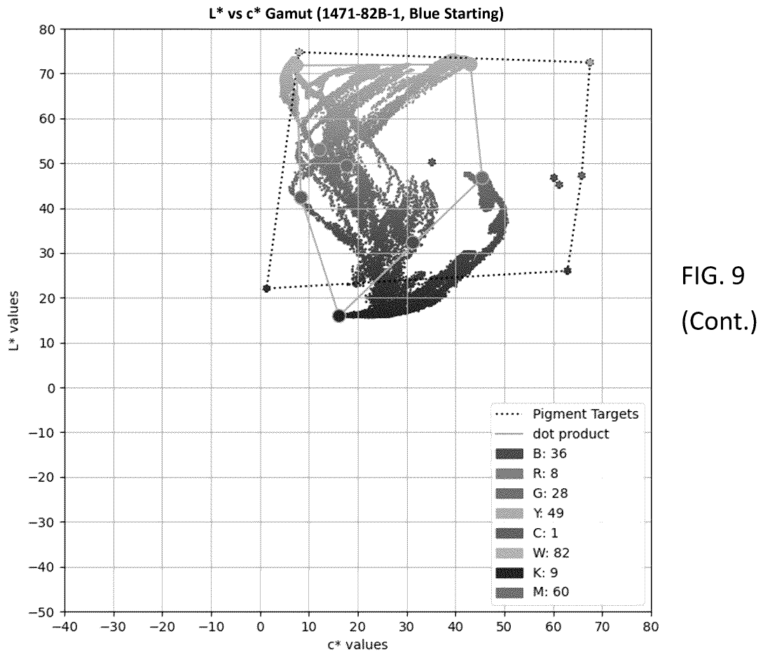

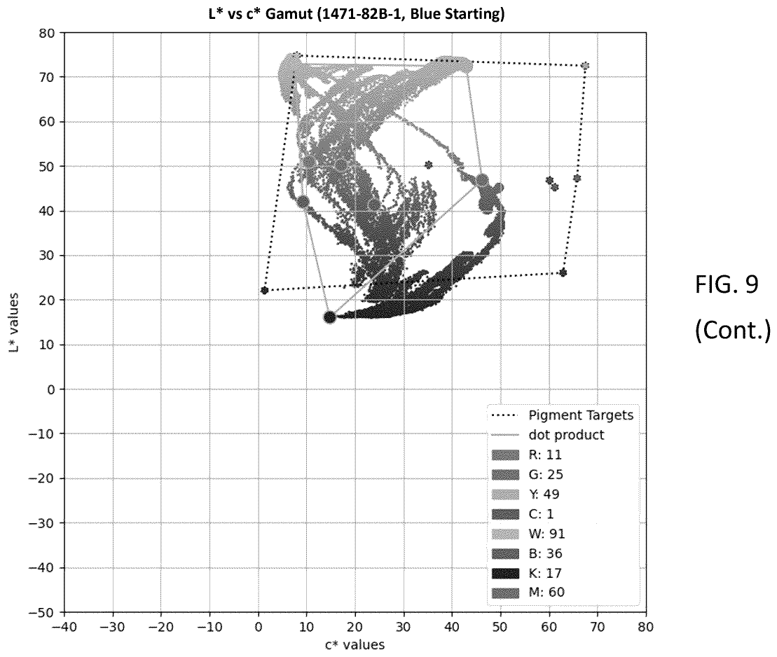

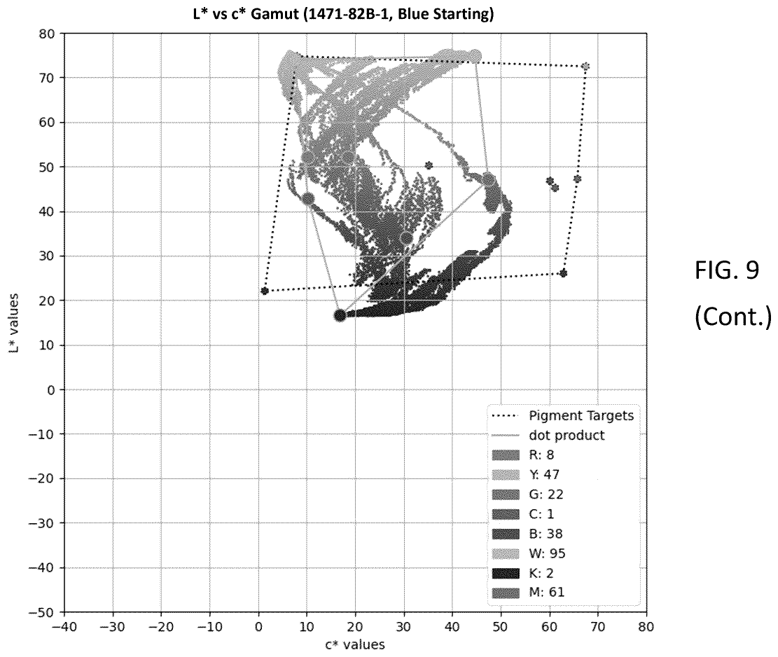

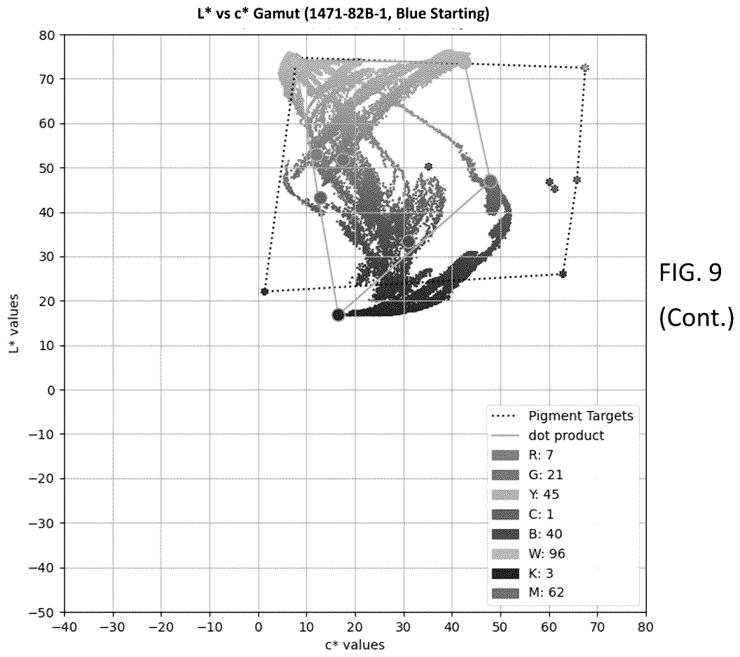

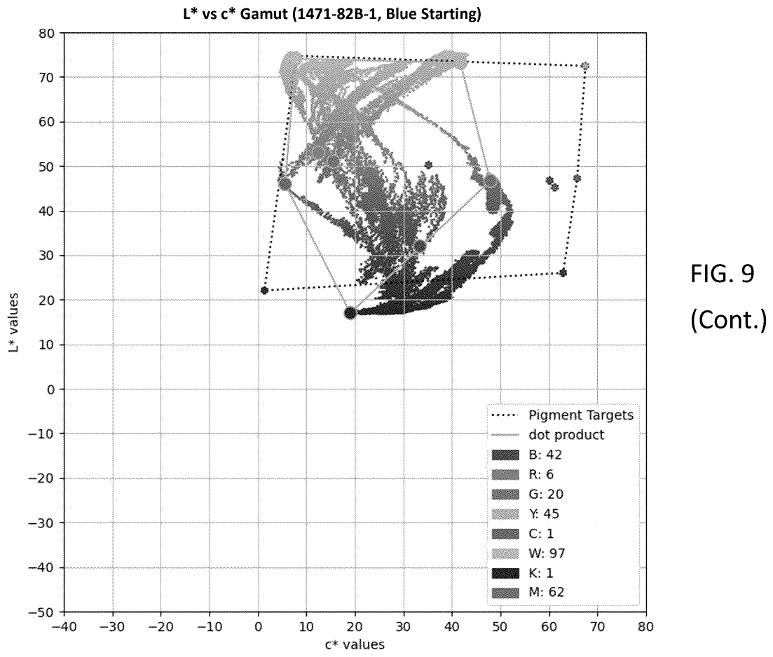

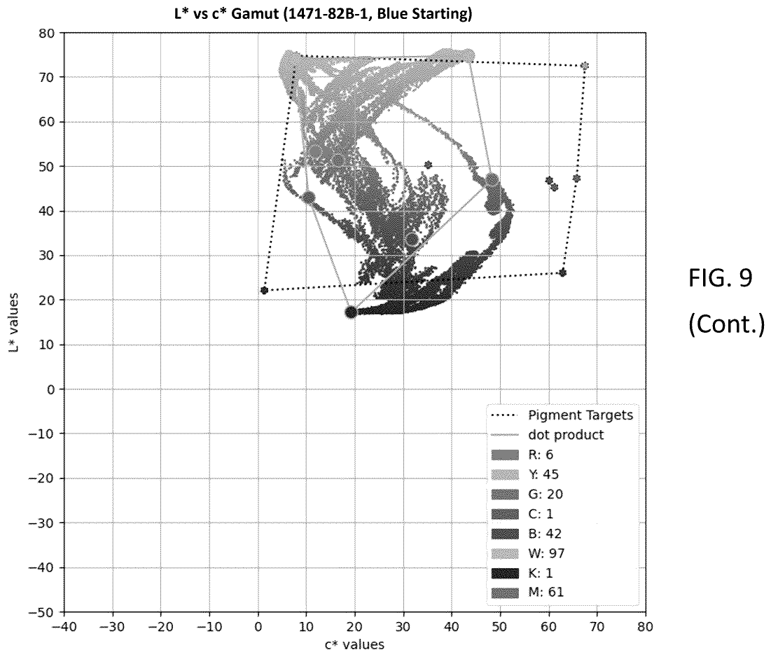

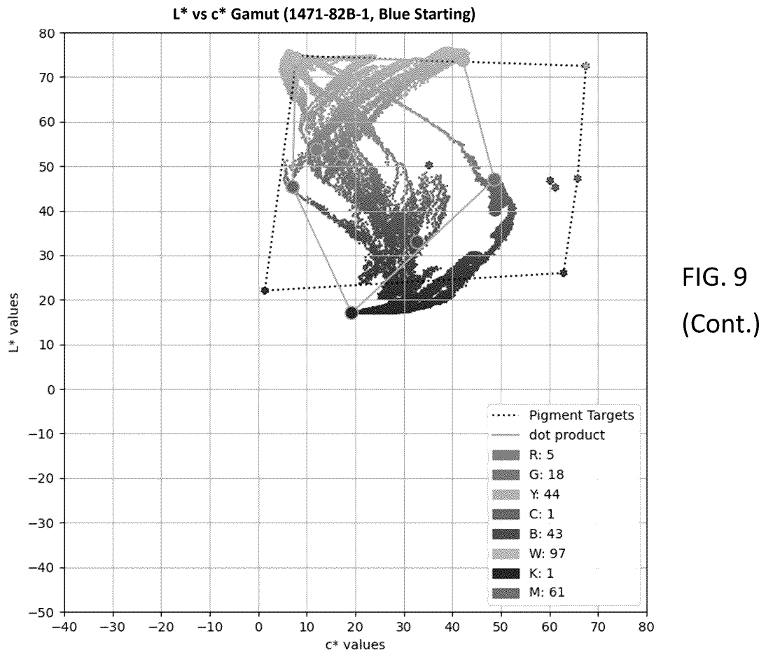

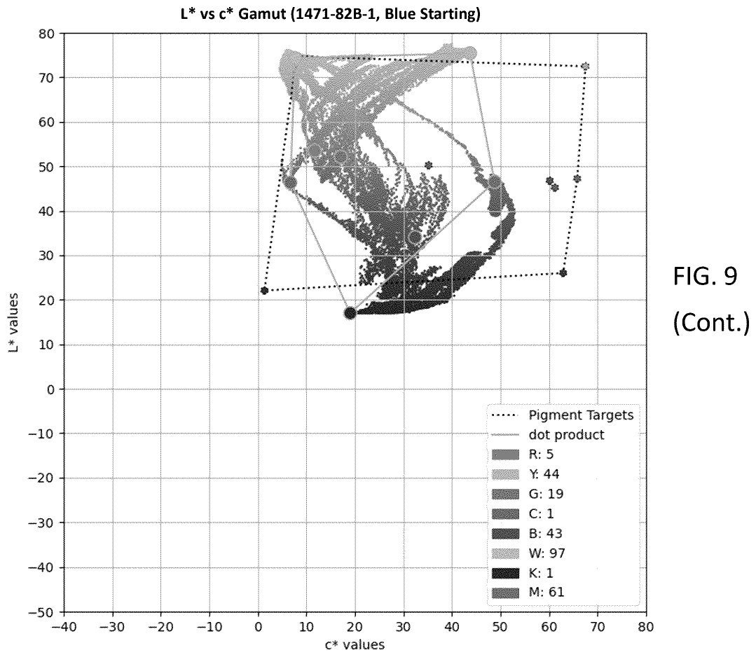

As shown in FIG. 9, the L*C* plots of the control and silicone surfactant samples confirmed the previous conclusions. Silicone surfactant sample indeed showed a higher L* value when c*<5 and a lower L* when c*<20, leading to better dark state and better white state quality. Thus, a higher CR for MCC samples with silicone surfactants was realized.

### Impedance of Binder Layer

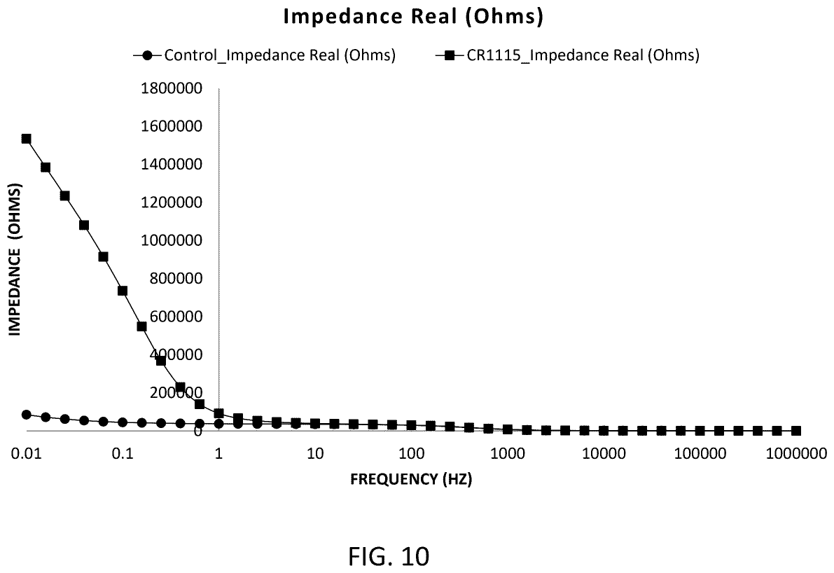

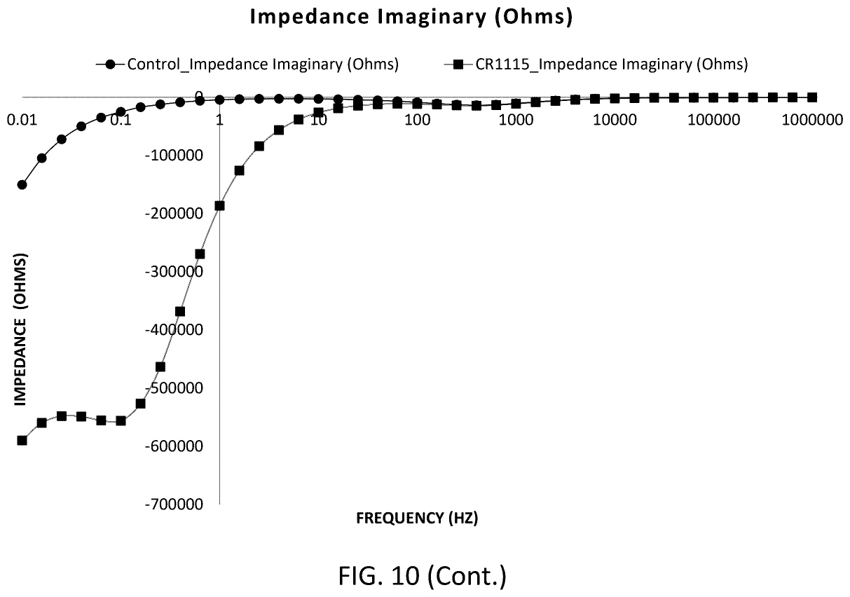

Without wishing to be bound to theory, the improved CR when utilizing a silicone surfactant may be related to the binder conductivity. With a Solatron impedance analyzer, the impedance of 2*3 ITO pixels (PIXs) was measured at room temperature. See FIG. 10.

It was observed that by adding silicone surfactants Silsurf® CR 1115, the impedance of the PIXs became higher compared to the control sample. One hypothesis is that when the impedance of the MCC ink layer increases, the voltage drop across the MCC capsules also becomes higher, which leads to better color performance.

I/We claim:

1. An electro-optic medium comprising a continuous phase and a discontinuous phase, wherein the discontinuous phase comprises a plurality of capsules and the continuous phase surrounds the discontinuous phase and comprises a binder, a rheology modifier, and a surfactant;
wherein the surfactant comprises a silicone polyether surfactant.

2. The electro-optic medium of claim 1, wherein the silicone polyether surfactant comprises a PEG/PPG-dimethicone.

3. The electro-optic medium of claim 1, wherein the dry mass weight ratio of capsule to surfactant is between 60:1 to 100:1.

4. The electro-optic medium of claim 1, wherein each capsule comprises at least three different kinds of charged pigment particles dispersed in a hydrocarbon solvent.

5. The electro-optic medium of claim 1, wherein each capsule comprises a first, a second, a third, and a fourth different kind of pigment particles.

6. The electro-optic medium of claim 5, wherein the four different kinds of pigment particles are white, yellow, magenta, and cyan pigment particles.

7. An electro-optic display comprising:
a light-transmissive top electrode;
an electro-optic medium comprising a continuous phase and a discontinuous phase; and
a backplane electrode;
wherein the discontinuous phase comprises a plurality of capsules and the continuous phase surrounds the discontinuous phase and comprises a binder, a rheology modifier, and a surfactant;
wherein the surfactant comprises a silicone polyether surfactant.

8. The electro-optic display of claim 7, wherein the silicone polyether surfactant comprises a PEG/PPG-dimethicone.

9. The electro-optic display of claim 7, wherein the dry mass weight ratio of capsule to surfactant is between 60:1 to 100:1.

10. The electro-optic display of claim 7, wherein each capsule comprises at least three different kinds of charged pigment particles dispersed in a hydrocarbon solvent.

11. The electro-optic display of claim 7, wherein each capsule comprises a first, a second, a third, and a fourth different kind of pigment particles.

12. The electro-optic display of claim 7, wherein the contrast ratio of the electro-optic display is at least 10 at −20 °C after 8 cycles as measured by a push-pull test.

13. The electro-optic display of claim 7, wherein the dark state L* of the electro-optic display is less than 25 at −20 °C after 8 cycles as measured by a push-pull test.

14. The electro-optic display of claim 7, wherein the white state L* of the electro-optic display is at least 65 at −20 °C after 8 cycles as measured by a push-pull test.

15. A method for preparing an electro-optic display comprising:
providing a first subassembly comprising an electro-optic medium layer and a first substrate, the electro-optic medium comprising a continuous phase and a discontinuous phase;
providing a second subassembly comprising a backplane electrode; and
laminating the two subassemblies to one another using a first lamination adhesive so that the electro-optic medium layer is disposed between the first substrate and the backplane electrode,
wherein the discontinuous phase comprises a plurality of capsules and the continuous phase surrounds the discontinuous phase and comprises a binder, a rheology modifier, and a surfactant;
wherein the surfactant comprises a silicone polyether surfactant.

16. The method of claim 15, wherein the first substrate comprises a light-transmissive top electrode, or wherein the method comprises laminating the first subassembly to a light-transmissive top electrode using a second lamination adhesive, wherein the first substrate comprises a release sheet.

17. The method of claim 15, wherein the silicone polyether surfactant comprises a PEG/PPG-dimethicone.

18. The method of claim 15, wherein the dry mass weight ratio of capsule to surfactant is between 60:1 to 100:1.

19. The method of claim 15, wherein each capsule comprises at least three different kinds of charged pigment particles dispersed in a hydrocarbon solvent.

20. The method of claim 15, wherein each capsule comprises a first, a second, a third, and a fourth kind of different pigment particles.
